(19) United States
(12) Patent Application Publication
(10) Pub. No.: US 2021/0143404 A1
(43) Pub. Date: May 13, 2021

(54) SECONDARY BATTERY, POSITIVE ELECTRODE FOR SECONDARY BATTERY, AND MANUFACTURING METHOD OF POSITIVE ELECTRODE FOR SECONDARY BATTERY

(71) Applicant: SEMICONDUCTOR ENERGY LABORATORY CO., LTD., ATSUGI-SHI (JP)

(72) Inventors: Mayumi MIKAMI, Atsugi (JP); Kazuhei NARITA, Tokyo (JP); Teruaki OCHIAI, Atsugi (JP); Yumiko YONEDA, Isehara (JP)

(73) Assignee: SEMICONDUCTOR ENERGY LABORATORY CO., LTD., ATSUGI-SHI (JP)

(21) Appl. No.: 17/086,959

(22) Filed: Nov. 2, 2020

(30) Foreign Application Priority Data
Nov. 11, 2019 (JP) 2019-203821
Jan. 23, 2020 (JP) 2020-009100

(51) Int. Cl. H01M 4/1397; H01M 4/04; H01M 4/62; H01M 4/58; H01M 10/0525; H01M 4/136

(52) U.S. Cl. CPC H01M 4/1397; H01M 4/0404; H01M 4/625; H01M 4/5825; H01M 2004/028; H01M 4/0471; H01M 10/0525; H01M 4/136; H01M 4/049

(57) ABSTRACT

A method for manufacturing a lithium-ion secondary battery more safely at a lower cost is provided. A method for manufacturing a positive electrode for a secondary battery includes a step of forming slurry by mixing graphene oxide, a binder, and a positive electrode active material in a solvent containing water; a step of applying the slurry on a positive electrode current collector; and a step of reducing graphene oxide by at least one of chemical reduction and thermal reduction. As a reducing agent for the chemical reduction, ascorbic acid can be used.

### BACKGROUND OF THE INVENTION

### 1. Field of the Invention

The present invention relates to an object, a method, or a manufacturing method. The present invention relates to a process, a machine, manufacture, or a composition of matter. In particular, one embodiment of the present invention relates to a semiconductor device, a display device, a light-emitting device, a secondary battery, a power storage device, a memory device, a driving method thereof, or a manufacturing method thereof. In particular, one embodiment of the present invention relates to a secondary battery, a power storage device, and a manufacturing method thereof.

Note that a secondary battery or a power storage device in this specification refers to every element and device having a function of storing electric power.

### 2. Description of the Related Art

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

Lithium-ion batteries using lithium iron phosphate (LiFePO₄, abbreviation: LFP) as a positive electrode active material have already been commercially available as home-use large secondary batteries or in-vehicle secondary batteries, for example (Non-Patent Document 1).

In recent years, graphene has been attracting a great deal of attention because of its excellent conductivity and the like, and a large-scale production method and the like have been searched. As described in Non-Patent Document 2, a compound obtained by reduction of graphene oxide (GO) is referred to as reduced GO (RGO) in some cases and the physical property thereof has been attracting attention. For example, there is a study such as Non-Patent Document 3 that characterized the physical property of GO using a scanning electron microscope (SEM), X-ray diffraction (XRD), Raman spectroscopy, and the like. Moreover, as disclosed in Patent Document 1, GO is used for a secondary battery, for example.

### REFERENCE

[Patent Document 1] Japanese Published Patent Application No. 2014-007141

### Non-Patent Document

[Non-Patent Document 1] Naoki Nitta et al., “Li-ion battery materials: present and future” Materials Today, vol. 18, No. 5, June. 2015, pp. 252-264.
[Non-Patent Document 2] A. Bagri et al., “Structural evolution during the reduction of chemically derived graphene oxide”, NATURE CHEMISTRY, vol. 2, 2010, pp. 581-587.
[Non-Patent Document 3] Burcu Saner et al., “Utilization of multiple graphene nanosheets in fuel cells: 2. The effect of oxidation process on the characteristics of graphene nanosheets”, Fuel, 90, 2011, pp. 2609-2616.
[Non-Patent Document 4] Kanichi Suzuki et al., “Carbonization characteristics of hydrocarbons treated in superheated steam”, Japan Society for Food Engineering, vol. 8, No. 1, March 2007, pp. 39-43.

### SUMMARY OF THE INVENTION

A lithium-ion battery using LFP as a positive electrode active material is promising in terms of safety and cost. Therefore, a larger number of lithium-ion batteries using LFP are expected to be manufactured in the future.

In a manufacturing process of electrodes of lithium-ion batteries including lithium-ion batteries using LFP, a large amount of organic solvent is used as a solvent of slurry obtained by mixing an active material, a conductive material, a binder, and the like, a solvent for wet mixing, and the like. The organic solvent is completely evaporated in a later step.

As an organic solvent for such a purpose, N-methylpyrrolidone (NMP), which is an aprotic polar solvent, is often used. However, NMP causes skin irritation and might have, for example, reproductive toxicity, and thus is a material harmful to health. Therefore, NMP is necessarily collected in a manufacturing factory so as not to be released to external environment. This step increases the manufacturing cost of a lithium-ion battery.

In view of this, when slurry can be formed using water as a solvent in a manufacturing process, a lithium-ion battery can be manufactured more safely at a lower cost.

An object of one embodiment of the present invention is to provide a method for manufacturing a positive electrode for a lithium-ion secondary battery using water as a solvent in a manufacturing process. Another object of one embodiment of the present invention is to provide a method for manufacturing a positive electrode for a lithium-ion secondary battery more safely. Another object of one embodiment of the present invention is to provide a method for manufacturing a lithium-ion secondary battery at a lower cost. Another object of one embodiment of the present invention is to provide a secondary battery with excellent cycle characteristics. Another object of one embodiment of the present invention is to provide a secondary battery with excellent rate characteristics. Another object of one embodiment of the present invention is to provide a higher-capacity secondary battery. Another object of one embodiment of the present invention is to provide a safer secondary battery. Another object of one embodiment of the present invention is to provide a novel power storage device.

Note that the description of these objects does not disturb the existence of other objects. One embodiment of the present invention does not need to achieve all the objects. Other objects can be derived from the description of the specification, the drawings, and the claims.

One embodiment of the present invention is a method for manufacturing a positive electrode for a secondary battery, including a step of forming slurry by mixing graphene oxide, a binder, and a positive electrode active material in a solvent containing water; a step of applying the slurry on a positive electrode current collector; and a step of reducing the graphene oxide. The step of reducing the graphene oxide includes at least one of chemical reduction and thermal reduction.

One embodiment of the present invention is a method for manufacturing a positive electrode for a secondary battery, including a step of forming slurry by mixing graphene oxide, a binder, and a positive electrode active material in a solvent containing water; a step of applying the slurry on a positive electrode current collector; and a step of reducing the graphene oxide. The step of reducing the graphene oxide includes chemical reduction and thermal reduction.

In the above, the chemical reduction is preferably a step of immersion in a reducing agent solution, and the thermal reduction is preferably a step of heating at a temperature higher than or equal to 125° C. and lower than or equal to 200° C. for longer than or equal to one hour and shorter than or equal to 20 hours.

In the above, the binder preferably includes polysaccharide. Moreover, the polysaccharide is preferably starch.

In the above, the reducing agent solution is preferably an ascorbic acid solution.

One embodiment of the present invention is a secondary battery including a positive electrode, a negative electrode, a separator, and an electrolyte solution. The positive electrode includes a positive electrode active material, a conductive material, a binder, and a positive electrode current collector; the positive electrode active material is lithium iron phosphate; and the conductive material is reduced graphene oxide.

In the above, the reduced graphene oxide preferably contains carbon and oxygen; the reduced graphene oxide preferably has a sheet-like shape and a two-dimensional structure formed of a six-membered ring composed of carbon atoms; and the concentration of carbon is preferably greater than 80 atomic % and the concentration of oxygen is preferably greater than or equal to 2 atomic % and less than or equal to 15 atomic % in part of the reduced graphene oxide.

In the above, the intensity ratio of a G band to a D band (G/D) of a Raman spectrum of the reduced graphene oxide is preferably greater than or equal to 1.

One embodiment of the present invention can provide a method for manufacturing a positive electrode for a lithium-ion secondary battery using water as a solvent in a manufacturing process. Another embodiment of the present invention can provide a method for manufacturing a positive electrode for a lithium-ion secondary battery more safely. Another embodiment of the present invention can provide a method for manufacturing a lithium-ion secondary battery at a lower cost. Another embodiment of the present invention can provide a secondary battery with excellent cycle characteristics. Another embodiment of the present invention can provide a secondary battery with excellent rate characteristics. Another embodiment of the present invention can provide a higher-capacity secondary battery. Another embodiment of the present invention can provide a safer secondary battery. Another object of one embodiment of the present invention can provide a novel power storage device.

Note that the description of these effects does not disturb the existence of other effects. One embodiment of the present invention does not need to have all the effects. Other effects will be apparent from and can be derived from the descriptions of the specification, the drawings, the claims, and the like.

### BRIEF DESCRIPTION OF THE DRAWINGS

In the accompanying drawings:

FIG. 1 shows an example of a method for manufacturing a positive electrode for a secondary battery of one embodiment of the present invention;

FIG. 2 shows an example of a method for manufacturing a positive electrode for a secondary battery of one embodiment of the present invention;

FIGS. 3A and 3B are cross-sectional views of an active material layer containing graphene and a graphene compound as conductive materials;

FIGS. 4A and 4B illustrate examples of a secondary battery;

FIGS. 5A to 5C illustrate an example of a secondary battery;

FIGS. 6A and 6B illustrate an example of a secondary battery;

FIGS. 7A and 7B illustrate a coin-type secondary battery, and FIG. 7C illustrates charging and discharging of the secondary battery;

FIGS. 8A to 8D illustrate a cylindrical secondary battery;

FIGS. 9A and 9B illustrate an example of a secondary battery;

FIGS. 10A1, 10A2, 10B1, and 10B2 illustrate an example of a secondary battery;

FIGS. 11A and 11B illustrate examples of a secondary battery;

FIG. 12 illustrates an example of a secondary battery;

FIGS. 13A to 13C illustrate a secondary battery;

FIGS. 14A and 14B illustrate a secondary battery;

FIG. 15 is an external view of a secondary battery;

FIG. 16 is an external view of a secondary battery;

FIGS. 17A to 17C illustrate a method for manufacturing a secondary battery;

FIGS. 18A to 18G illustrate examples of electronic devices;

FIGS. 19A to 19C illustrate an example of an electronic device;

FIG. 20 illustrates examples of electronic devices;

FIGS. 21A to 21C illustrate examples of electronic devices;

FIGS. 22A to 22C illustrate examples of electronic devices;

FIGS. 23A to 23C illustrate examples of vehicles;

FIG. 24 is a photograph of a GO film fabricated in Example 1;

FIG. 25 shows Raman spectra of samples analyzed in Example 1;

FIG. 26 shows FT-IR spectra of samples analyzed in Example 1;

FIG. 27 shows XRD spectra of samples analyzed in Example 1;

FIG. 28 shows surface resistivities of samples analyzed in Example 1;

FIG. 29 shows XRD spectra of samples analyzed in Example 1;

FIG. 30 shows FT-IR spectra of samples analyzed in Example 1;

FIG. 31 is a surface SEM image of a sample analyzed in Example 1;

FIG. 32A is a cross-sectional SEM image of a sample fabricated in Example 1, and FIG. 32B is a diagram in which parts of RGO in FIG. 32A are traced by black lines for easy understanding;

FIG. 33A shows discharge curves of samples fabricated in Example 2, and FIG. 33B is a graph showing rate characteristics of the sample fabricated in Example 2;

FIG. 34A shows discharge curves per weight of samples fabricated in Example 2, and FIG. 34B shows discharge curves per volume of the samples fabricated in Example 2;

FIGS. 35A and 35B are discharge curves showing rate characteristics of samples fabricated in Example 2;

FIGS. 36A and 36B are graphs showing rate characteristics of samples fabricated in Example 3;

FIGS. 37A and 37B are graphs showing rate characteristics of samples fabricated in Example 3;

FIGS. 38A and 38B are graphs showing rate characteristics of samples fabricated in Example 3;

FIGS. 39A to 39C are graphs showing cycle characteristics of samples fabricated in Example 3;

FIGS. 40A and 40B are graphs showing rate characteristics of samples fabricated in Example 3;

FIGS. 41A and 41B are graphs showing charge curves of samples fabricated in Example 3;

FIGS. 42A and 42B are surface SEM images of a sample fabricated in Example 4;

FIG. 43A shows charge and discharge curves of a sample fabricated in Example 4, and FIG. 43B shows a discharge energy retention rate of the sample fabricated in Example 4;

FIG. 44 is a graph showing cycle performance of samples fabricated in Example 4;

FIG. 45 is a graph showing cycle performance of samples fabricated in Example 4;

FIG. 46A shows charge and discharge curves of a sample fabricated in Example 4, and FIG. 46B shows a discharge energy retention rate of the sample;

FIG. 47A shows charge and discharge curves of a sample fabricated in Example 4, and FIG. 47B shows a discharge energy retention rate of the sample;

FIG. 48A shows charge and discharge curves of a sample fabricated in Example 4, and FIG. 48B shows a discharge energy retention rate of the sample; and

FIG. 49 is a graph showing capacities per volume of samples fabricated in Example 4.

### DETAILED DESCRIPTION OF THE INVENTION

Embodiments and an example of the present invention will be described in detail below with reference to the accompanying drawings. However, the present invention is not limited to the description of the embodiments and example and it is easily understood by those skilled in the art that the mode and details can be changed variously. Therefore, the present invention should not be construed as being limited to the description in the following embodiments.

Note that in drawings used in this specification, the sizes, thicknesses, and the like of components such as films, layers, substrates, regions are exaggerated for simplicity in some cases. Therefore, the sizes of the components are not limited to the sizes in the drawings and relative sizes between the components.

Note that the ordinal numbers such as “first” and “second” in this specification and the like are used for convenience and do not denote the order of steps, the stacking order of layers, or the like. Therefore, for example, description can be made even when “first” is replaced with “second” or “third”, as appropriate. In addition, the ordinal numbers in this specification and the like are not necessarily the same as those used to specify one embodiment of the present invention.

Note that in the structures of the present invention described in this specification and the like, the same portions or portions having similar functions in different drawings are denoted by the same reference numerals, and description of such portions is not repeated. Further, the same hatching pattern is applied to portions having similar functions, and the portions are not especially denoted by reference numerals in some cases.

Note that in this specification and the like, a positive electrode and a negative electrode for a power storage device may be collectively referred to as an electrode; in this case, the electrode refers to at least one of the positive electrode and the negative electrode for the power storage device.

In this specification and the like, as a secondary battery of one embodiment of the present invention, which uses a positive electrode and a positive electrode active material, a lithium metal is used for a counter electrode in some cases; however, an example of the secondary battery of one embodiment of the present invention is not limited thereto. Another material such as graphite or lithium titanate may be used for a negative electrode, for example. A preferable property of the positive electrode of one embodiment of the present invention is not affected by the material of the negative electrode.

### Embodiment 1

In this embodiment, examples of a method for manufacturing a positive electrode for a secondary battery of one embodiment of the present invention are described with reference to FIG. 1 and FIG. 2.

### <Step S11>

First, as Step S11, a positive electrode active material, a conductive material, a binder, and a current collector that are materials of the positive electrode are prepared. A solvent for mixing is also prepared.

### [Positive Electrode Active Material]

Examples of the positive electrode active material include a composite oxide with an olivine crystal structure, a composite oxide with a layered rock-salt crystal structure, and a composite oxide with a spinel crystal structure. For example, compounds such as LFP, lithium manganese phosphate (LiMnPO₄), lithium ferrate (LiFeO₂), lithium cobalt oxide (LiCoO₂), lithium nickelate (LiNiO₂), lithium manganese oxide (LiMn₂O₄), V₂O₅, Cr₂O₅, and MnO₂ are given. Alternatively, lithium cobalt oxide in which manganese is substituted for part of cobalt, lithium cobalt oxide in which nickel is substituted for part of cobalt, lithium nickel-cobalt-manganese oxide, lithium nickel-cobalt-aluminum oxide, or the like may be used. Alternatively, a mixture thereof may be used. An additive such as magnesium or halogen typified by fluorine may be added to a positive electrode active material.

It is particularly preferable to use LFP because it has a high level of safety, excellent cycle characteristics, and a wide plateau, and is advantageous in reducing cost because of including iron, which is cheaper than cobalt.

Lithium cobalt oxide is preferable because it has high capacity and higher stability in the air and higher thermal stability than lithium nickelate, for example.

It is preferable to add a small amount of lithium nickel oxide (LiNiO₂ or LiNi₁₋ₓMₓO₂ (0<x<1) (M=Co, Al, or the like)) to a lithium-containing material with a spinel crystal structure which contains manganese such as LiMn₂O₄ because characteristics of the secondary battery using such a material can be improved.

Another example of the positive electrode active material is a lithium-manganese composite oxide that is represented by a composition formula LiₐMn_{b}M_{c}O_{d}. Here, the element M is preferably a metal element other than lithium and manganese, or silicon or phosphorus, more preferably nickel. In the case where the whole particle of a lithium-manganese composite oxide is measured, it is preferable to satisfy the following at the time of discharging: 0<a/(b+c)<2; c>0; and 0.26≤(b+c)/d<0.5. Note that the ratios of metal, silicon, phosphorus, and other elements to the total composition in the whole particle of a lithium-manganese composite oxide can be measured with, for example, an inductively coupled plasma mass spectrometer (ICP-MS). The ratio of oxygen to the total composition in the whole particle of a lithium-manganese composite oxide can be measured by, for example, energy dispersive X-ray spectroscopy (EDX). Alternatively, the ratio of oxygen to the total composition in the whole particle of a lithium-manganese composite oxide can be measured by ICP-MS combined with fusion gas analysis and valence evaluation of X-ray absorption fine structure (XAFS) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### [Conductive Material]

Examples of the conductive material include natural graphite, artificial graphite such as mesocarbon microbeads, and carbon fiber. Examples of carbon fiber include mesophase pitch-based carbon fiber, isotropic pitch-based carbon fiber, carbon nanofiber, and carbon nanotube. Examples of carbon fiber include mesophase pitch-based carbon fiber, isotropic pitch-based carbon fiber, carbon nanofiber, and carbon nanotube. Carbon nanotube can be formed by, for example, a vapor deposition method. Other examples of the conductive material include carbon materials such as carbon black (e.g., acetylene black (AB)), graphite (black lead) particles, graphene, and fullerene. Alternatively, metal powder or metal fibers of copper, nickel, aluminum, silver, gold, or the like, or a conductive ceramic material can be used, for example.

In particular, graphene and a graphene compound are preferably used as the conductive materials. It is particularly preferable that GO be used as an initial material and be made RGO through a reduction step described later.

A graphene compound in this specification and the like refers to multilayer graphene, multi graphene, GO, multilayer GO, multi GO, RGO, multilayer RGO, multi RGO, and the like. A graphene compound contains carbon, has a plate-like shape, a sheet-like shape, or the like, and has a two-dimensional structure formed of a six-membered ring composed of carbon atoms. The graphene compound is preferably bent. The graphene compound may be referred to as a carbon sheet. The graphene compound preferably includes a functional group. The graphene compound may be rounded like a carbon nanofiber.

In this specification and the like, GO contains carbon and oxygen, has a sheet-like shape, and includes a functional group, in particular, an epoxy group, a carboxy group, or a hydroxy group.

In this specification and the like, RGO contains carbon and oxygen, has a sheet-like shape, and has a two-dimensional structure formed of a six-membered ring composed of carbon atoms. The RGO may also be referred to as a carbon sheet. The RGO functions by itself and may have a stacked-layer structure. The RGO preferably includes a portion where the carbon concentration is higher than 80 atomic % and the oxygen concentration is higher than or equal to 2 atomic % and lower than or equal to 15 atomic %. With such a carbon concentration and such an oxygen concentration, the RGO can function as a conductive material with high conductivity even with a small amount. In addition, the intensity ratio G/D of a G band to a D band of the Raman spectrum of the RGO is preferably 1 or more. The RGO with such an intensity ratio can function as a conductive material with high conductivity even with a small amount.

In this embodiment, GO is prepared as a material of the conductive material and is reduced in a later step. The conductive material included in a completed positive electrode is RGO.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, a graphene compound sometimes has extremely high conductivity even with a small thickness, and thus a small amount of a graphene compound efficiently allows a conductive path to be formed in an active material layer. Hence, a graphene compound is preferably used as the conductive material, in which case the area where the active material and the conductive material are in contact with each other can be increased. Note that a graphene compound preferably clings (sticks) to at least part of an active material particle. A graphene compound preferably overlays (superposes) an active material particle. The shape of a graphene compound preferably conforms to (mirrors) at least part of the shape of a plurality of active material particles. The shape of a plurality of active material particles means, for example, projections and depressions of a single active material particle or projections and depressions formed by a plurality of active material particles. A graphene compound preferably surrounds at least part of an active material particle. A graphene compound may have a hole (opening).

In the case where active material particles with a small diameter (e.g., 1 μm or less) are used, the specific surface area of the active material particles is large and thus more conductive paths for the active material particles are needed. In such a case, it is particularly preferred that a graphene compound that can efficiently form a conductive path even with a small amount be used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and discharge characteristics in some cases. In addition, a mobile electronic device or the like is required to have fast charge characteristics in some cases. Fast charging and discharging may also be referred to as charging and discharging at a high rate, for example, at 1 C, 2 C, or 5 C or more.

### [Binder]

For the binder, for example, water-soluble polymers are preferably used. As the water-soluble polymers, for example, a polysaccharide can be used. Examples of the polysaccharide include cellulose derivatives such as carboxymethyl cellulose (CMC), methyl cellulose, ethyl cellulose, hydroxypropyl cellulose, diacetyl cellulose, and regenerated cellulose and starch. It is further preferable that such water-soluble polymers be used in combination with any of rubber materials described later.

As the binder, a rubber material such as styrene-butadiene rubber (SBR), styrene-isoprene-styrene rubber, acrylonitrile-butadiene rubber, butadiene rubber, fluororubber, or ethylene-propylene-diene copolymer can be used. Alternatively, fluororubber can be used as the binder.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used. In this specification and the like, starch refers to a polymer in which α-glucose is polymerized. Since starch with a higher polymerization degree can function as an excellent binder, the polymerization degree is preferably higher than or equal to 500, further preferably higher than or equal to 1000. Note that there is no limitation on whether starch is gelatinized or not. In addition, there is no limitation on the branch ratio and the kind of a plant that is a raw material. Starch may include monosaccharide and disaccharide such as glucose and maltose, another polysaccharide such as cellulose, or impurities such as phosphoric acid and amino acid.

Note that a cellulose derivative such as carboxymethyl cellulose obtains a higher solubility when converted into a salt such as a sodium salt or an ammonium salt of carboxymethyl cellulose, and accordingly easily exerts an effect as a viscosity modifier. A high solubility can also increase the dispersibility of an active material and other components in the formation of slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed to an active material surface because it has a functional group. Many cellulose derivatives, such as carboxymethyl cellulose, have functional groups such as a hydroxy group and a carboxy group. Because of functional groups, polymers are expected to interact with each other and cover an active material surface in a large area.

In the case where the binder covering or being in contact with the active material surface forms a film, the film is expected to serve also as a passivation film to suppress the decomposition of the electrolyte solution. Here, the passivation film refers to a film without electric conductivity or a film with extremely low electric conductivity, and can inhibit the decomposition of an electrolytic solution at a potential at which a battery reaction occurs when the passivation film is formed on the active material surface, for example. It is preferred that the passivation film can conduct lithium ions while suppressing electric conduction.

When polysaccharide typified by starch is used as the binder, at least part of the polysaccharide is preferably reduced through a reduction step described later. Therefore, a completed positive electrode preferably includes reduced polysaccharide as the binder. The reduced polysaccharide has improved conductivity and thus can form a more favorable conductive path in a positive electrode active material layer in combination with the conductive material.

It is particularly effective to use polysaccharide and GO as the binder and the conductive material, respectively. Dehydration condensation occurs between a functional group of polysaccharide or reduced polysaccharide and a functional group of GO or RGO, so that a covalent bond is formed, which functions as a more favorable binder and conductive material even with a small amount in some cases.

### [Current Collector]

The current collector can be formed using a material that has high conductivity, such as a metal like stainless steel, gold, platinum, aluminum, or titanium or an alloy thereof. It is preferred that a material used for the positive electrode current collector not dissolve at the potential of the positive electrode. Alternatively, the positive electrode current collector can be formed using an aluminum alloy to which an element that improves heat resistance, such as silicon, titanium, neodymium, scandium, or molybdenum, is added. Still alternatively, a metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape (sheet-like shape), a net-like shape, a punching-metal shape, an expanded-metal shape, or the like as appropriate. The current collector preferably has a thickness greater than or equal to 5 μm and less than or equal to 30 μm.

### [Solvent]

The solvent for mixing preferably has polarity. Examples of a polar solvent include water, NMP, methanol, ethanol, acetone, and dimethylformamide (DMF). Water is particularly preferable because it has a high polarity and puts little strain on environment and the human body. Moreover, mixture of water and another material may be used as the solvent for mixing. The volume ratio of the water contained in the mixture is preferably greater than or equal to 10 volume %, further preferably greater than or equal to 50 volume %, still further preferably greater than or equal to 90 volume %.

### <Step S12>

Next, the binder, the conductive material, and the positive electrode active material are mixed. Mixing can be performed in, although not limited to, the following order as shown in FIG. 1, for example: the binder and the solvent are mixed (Step S12a), the conductive material is mixed therein (Step S12b), and then the positive electrode active material is mixed therein (Step S12c). In Step S12c, the solvent is preferably added to adjust the viscosity.

Alternatively, mixing can be performed in the following order as shown in FIG. 2: the positive electrode active material and the solvent are mixed (Step S12d), the conductive material is mixed therein (Step S12e), and then the binder is mixed therein (Step S120. In Step S12f, the solvent is preferably added to adjust the viscosity.

### <Step S13>

The mixture obtained by mixing the binder, the conductive material, and the positive electrode active material with the solvent in the above-described manner is used as slurry (Step S13).

### <Step S14>

Next, as Step S14, application of the slurry on the current collector is performed. For the application, a doctor blade can be used, for example. The carried amount can be adjusted by adjusting a blade gap in the application.

### <Step S15>

Then, as Step S15, the applied slurry is dried to be an electrode layer. The shapes of the current collector and the electrode layer may be processed by stamping as necessary, for example.

### <Step S16>

Next, as Step S16, reduction treatment is performed on the electrode layer. As the reduction treatment, at least one of chemical reduction and thermal reduction can be performed.

### [Chemical Reduction]

Chemical reduction refers to treatment using a reducing agent. Examples of the reducing agent include organic acid typified by ascorbic acid, hydrogen, sulfur dioxide, sulfurous acid, sodium sulfite, sodium hydrogen sulfite, ammonium sulfite, and phosphorous acid.

In the case where ascorbic acid is used as a reducing agent, first, ascorbic acid is dissolved in a solvent to form a reducing agent solution (ascorbic acid solution). As the solvent, water, a mixture of water and NMP, ethanol, a mixture of water and ethanol, or the like can be used. Then, the electrode layer formed in Step S15 is immersed in the solution. This treatment can be performed for longer than or equal to 30 minutes and shorter than or equal to 10 hours, preferably approximately one hour. Moreover, heating is preferably performed because the chemical reduction time can be shortened. The mixture can be heated to higher than or equal to room temperature and lower than or equal to 100° C., preferably approximately 60° C., for example.

### [Thermal Reduction]

Thermal reduction refers to treatment for heating the electrode layer formed in Step S15. The heating is preferably performed under a reduced pressure. A glass tube oven can be used for the heating, for example. A glass tube oven can perform heating under a reduced pressure of approximately 1 kPa.

The optimal heating temperature and heating time are different depending on materials of the conductive material and the binder. In the case where GO is used as the conductive material and PVDF is used as the binder, for example, the temperature is preferably a temperature at which the GO is sufficiently reduced and the PVDF is not adversely affected. Specifically, the temperature is preferably higher than or equal to 125° C. and lower than or equal to 200° C. At a temperature lower than or equal to 100° C., there is concern that reduction of the GO does not sufficiently proceed. Meanwhile, at a temperature higher than or equal to 250° C., the PVDF is adversely affected and there is concern that the slurry is likely to be separated from the current collector. The heating time is preferably longer than or equal to one hour and shorter than or equal to 20 hours. In the case where the heating time is shorter than one hour, there is concern that the GO is not sufficiently reduced. Meanwhile, in the case where the heating time is longer than 20 hours, productivity is decreased.

In the case where GO is used as the conductive material and starch is used as the binder, the temperature is preferably higher than the temperature in the case of using PVDF as the binder. Specifically, heating is preferably performed at a temperature higher than or equal to 200° C. and lower than or equal to 300° C. Heating is preferably performed at a temperature higher than or equal to 200° C. in order to sufficiently reduce and carbonize starch (see Non-Patent Document 4). Meanwhile, the temperature is preferably lower than or equal to 300° C. because an excessively high temperature might require, for example, a special heating apparatus, that is, might increase the cost. The heating time is preferably longer than or equal to one hour and shorter than or equal to 20 hours. In the case where the heating time is shorter than one hour, there is concern that reduction of the GO is not sufficiently reduced. Meanwhile, in the case where the heating time is longer than 20 hours, productivity is decreased.

At least one of chemical reduction and thermal reduction can be performed as the reduction treatment, and it is more preferable that both chemical reduction and thermal reduction be performed. In that case, thermal reduction may be performed after chemical reduction, or chemical reduction may be performed after thermal reduction. For example, chemical reduction and thermal reduction can be performed as Step S16a and Step S16b shown in FIG. 2, respectively.

A functional group that is likely to be reduced is different between chemical reduction and thermal reduction. Chemical reduction by protonation using a reducing agent is effective in reducing a carbonyl group (C═O) and a carboxy group (—COOH) in GO. In contrast, thermal reduction by dehydration is effective in reducing a hydroxy group (—OH) in GO. Therefore, performing both chemical reduction and thermal reduction can achieve efficient reduction and improve conductivity of RGO.

### <Step S17>

Next, as shown in Step S17 in FIG. 2, the component subjected to the reduction treatment may be pressed. A calendar roll can be used for the press, for example. The press can increase the density of the positive electrode active material layer.

### <Step S18>

The component formed in such a manner is a positive electrode of one embodiment of the present invention (Step S18).

By forming slurry using water as a solvent as described above, a positive electrode can be manufactured more safely at a lower cost than a conventional one. Furthermore, since graphene and a graphene compound are used as conductive materials, a positive electrode having high rate characteristics can be manufactured.

This embodiment can be implemented in combination with any of the other embodiments.

### Embodiment 2

In this embodiment, examples of a secondary battery of one embodiment of the present invention are described with reference to FIGS. 3A and 3B, FIGS. 4A and 4B. FIGS. 5A to 5C, and FIGS. 6A and 6B.

### Structure Example 1 of Secondary Battery

Hereinafter, a secondary battery in which a positive electrode, a negative electrode, and an electrolyte solution are wrapped in an exterior body is described as an example.

### [Positive Electrode]

As the positive electrode, the positive electrode described in the above embodiment is used. A cross-sectional structure example of an active material layer 200 containing graphene and a graphene compound as conductive materials is described below.

FIG. 3A is a longitudinal cross-sectional view of the active material layer 200. The active material layer 200 includes particles of a positive electrode active material 100, graphene and a graphene compound 201 serving as conductive materials, and a binder (not illustrated). Here, the graphene and graphene compound 201 preferably have a sheet-like shape or a flat-plate like shape. Alternatively, the graphene and graphene compound 201 may have a sheet-like shape or a flat-plate like shape formed of a plurality of sheets of multilayer graphene and/or a plurality of sheets of graphene that partly overlap each other.

The longitudinal cross section of the active material layer 200 in FIG. 3A shows substantially uniform dispersion of the sheet-like graphene and graphene compounds 201 in the active material layer 200. The graphene and graphene compounds 201 are schematically shown by thick lines in FIGS. 3A and 3B but are actually thin films each having a thickness corresponding to the thickness of a single layer or a multi-layer of carbon molecules. The plurality of graphene and graphene compounds 201 are formed to partly coat or adhere to the surfaces of the plurality of particles of the positive electrode active material 100, so that the graphene and graphene compounds 201 make surface contact with the particles of the positive electrode active material 100.

Here, the plurality of graphene and graphene compounds are bonded to each other to form a net-like graphene compound sheet (hereinafter referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume or weight. That is to say, the capacity of the secondary battery can be increased.

Here, it is preferable to perform reduction after a layer to be the active material layer 200 is formed in such a manner that GO is used as the graphene and graphene compound 201 and mixed with an active material. When GO with extremely high dispersibility in a polar solvent is used for the formation of the graphene and graphene compound 201, the graphene and graphene compounds 201 can be substantially uniformly dispersed in the active material layer 200. The solvent is removed by volatilization from a dispersion medium in which GO is uniformly dispersed, and the GO is reduced; hence, the graphene and graphene compounds 201 remaining in the active material layer 200 partly overlap each other and are dispersed such that surface contact is made, thereby forming a three-dimensional conduction path. Note that the GO can be reduced by heat treatment or treatment using a reducing agent, for example, and it is preferable to perform both heat treatment and treatment using a reducing agent.

Unlike a conductive material in the form of particles, such as AB, which makes point contact with an active material, the graphene and graphene compound 201 are capable of making low-resistance surface contact; accordingly, the electrical conduction between the particles of the positive electrode active material 100, and the graphene and graphene compound 201 can be improved with a small amount of the graphene and graphene compound 201 compared with a normal conductive material. Thus, the proportion of the positive electrode active material 100 in the active material layer 200 can be increased, resulting in increased discharge capacity of the secondary battery.

Alternatively, graphene and a graphene compound each serving as a conductive material can be formed in advance with a spray dry apparatus as coating films to cover the entire surface of the active material, and a conductive path between the active material particles can be formed using the graphene and graphene compound.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiO_{y}. Here, y preferably has an approximate value of 1. For example, y is preferably more than or equal to 0.2 and less than or equal to 1.5, further preferably more than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into graphite (while a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the nitride containing lithium and a transition metal can be used for the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

### [Negative Electrode Current Collector]

For the negative electrode current collector, a material similar to that of the positive electrode current collector can be used. Note that a material that is not alloyed with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are less likely to burn and volatize as the solvent of the electrolyte solution can prevent a secondary battery from exploding or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination in an appropriate ratio.

The electrolyte solution used for a secondary battery is preferably highly purified and contains small numbers of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a PEO-based gel, a polypropylene oxide-based gel, a fluorine-based polymer gel, or the like can be used.

Examples of the polymer include a polymer having a polyalkylene oxide structure, such as PEO; PVDF; polyacrylonitrile; and a copolymer containing any of them. For example, PVDF-HFP, which is a copolymer of PVDF and hexafluoropropylene (HFP) can be used. The formed polymer may be porous.

Instead of the electrolyte solution, a solid electrolyte including an inorganic material such as a sulfide-based or oxide-based inorganic material, or a solid electrolyte including a polymer material such as a PEO-based polymer material may alternatively be used. When the solid electrolyte is used, a separator and a spacer are not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Structure Example 2 of Secondary Battery

A structure of a secondary battery including a solid electrolyte layer will be described below as another structure example of a secondary battery.

As illustrated in FIG. 4A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when metal lithium is used for the negative electrode 430, it is possible that the negative electrode 430 does not include the solid electrolyte 421 as illustrated in FIG. 4B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S-30P₂S₅, 30Li₂S.26B₂S₃.44LiI, 63Li₂S.36SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-z}Li_{3z}TiO₃ (0<z<2/3)), a material with a NASICON crystal structure (e.g., Li_{1+A}Al_{A}Ti_{2-A}(PO₄)₃ (0<A<1)), a material with a garnet crystal structure (e.g., Li₇La₃Zr₂O₁₂), a material with a LISICON crystal structure (e.g., Li₁₄ZnGe₄O₁₆), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and Lil. Moreover, a composite material in which pores of porous aluminum oxide or porous silica are filled with such a halide-based solid electrolyte can be used as the solid electrolyte.

Alternatively, different solid electrolytes may be mixed and used.

In particular, Li_{1+B}Al_{B}Ti_{2-B}(PO₄)₃ (0<B<1) having a NASICON crystal structure (hereinafter LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

FIGS. 5A to 5C show an example of a cell for evaluating materials of an all-solid-state battery.

FIG. 5A is a schematic cross-sectional view of the evaluation cell. The evaluation cell includes a lower component 761, an upper component 762, and a fixation screw and a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 5B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 5C. Note that the same portions in FIGS. 5A to 5C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. When the exterior body is sealed, the air is preferably blocked in a closed atmosphere, for example, in a glove box.

FIG. 6A is a perspective view of a secondary battery of one embodiment of the present invention that has an exterior body and a shape different from those in FIGS. 5A to 5C. The secondary battery in FIG. 6A includes external electrodes 771 and 772 and is sealed with an exterior body including a plurality of package components.

FIG. 6B illustrates an example of a cross section along the dashed-dotted line in FIG. 6A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be implemented in appropriate combination with any of the other embodiments.

### Embodiment 3

In this embodiment, examples of the shape of a secondary battery containing the positive electrode described in the above embodiment will be described. For the materials used for the secondary battery described in this embodiment, refer to the description of the above embodiment.

### <Coin-Type Secondary Battery>

First, an example of a coin-type secondary battery is described. FIG. 7A is an external view of a coin-type (single-layer flat-type) secondary battery, and FIG. 7B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte solution. Then, as illustrated in FIG. 7B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In this manner, the coin-type secondary battery 300 is manufactured.

When the positive electrode described in the above embodiment is used as the positive electrode 304, the coin-type secondary battery 300 having excellent rate characteristics can be manufactured at a low cost.

Here, a current flow in charging a secondary battery is described with reference to FIG. 7C. When a secondary battery using lithium is regarded as a closed circuit, lithium ions transfer and a current flows in the same direction. Note that in the secondary battery using lithium, an anode and a cathode change places in charging and discharging, and an oxidation reaction and a reduction reaction occur on the corresponding sides; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charging is performed, discharging is performed, a reverse pulse current is supplied, and a charge current is supplied. The use of the terms “anode” and “cathode”, which are related to an oxidation reaction and a reduction reaction, might cause confusion because the anode and the cathode change places at the time of charging and discharging. Therefore, the terms “anode” and “cathode” are not used in this specification. If the term “anode” or “cathode” is used, whether it is at the time of charging or discharging is noted, as well as whether the term corresponds to a positive (plus) electrode or a negative (minus) electrode.

A charger is connected to the two terminals in FIG. 7C, and the secondary battery 300 is charged. As the charging of the secondary battery 300 proceeds, a potential difference between the electrodes increases.

### <Cylindrical Secondary Battery>

Next, an example of a cylindrical secondary battery is described with reference to FIGS. 8A to 8D. FIG. 8A is an external view of a cylindrical secondary battery 600. FIG. 8B is a schematic cross-sectional view of the cylindrical secondary battery 600. As illustrated in FIG. 8B, the cylindrical secondary battery 600 includes a positive electrode cap (battery lid) 601 on the top surface and a battery can (outer can) 602 on the side and bottom surfaces. The positive electrode cap 601 and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

As illustrated in FIG. 8C, a plurality of secondary batteries 600 may be sandwiched between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 8D is a top view of the module 615. The conductive plate 613 is shown by a dotted line for clarity of the drawing. As illustrated in FIG. 8D, the module 615 may include a conductive wire 616 that electrically connects the plurality of secondary batteries 600 to each other. The conductive plate can be provided over the conductive wire 616 to overlap each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature. A heating medium included in the temperature control device 617 preferably has an insulating property and incombustibility.

When the positive electrode described in the above embodiment is used as the positive electrode 604, the cylindrical secondary battery 600 having excellent rate characteristics can be manufactured at a low cost.

### <Structure Examples of Secondary Battery>

Other structure examples of secondary batteries will be described with reference to FIGS. 9A and 9B, FIGS. 10A1, 10A2, 10B1, and 10B2, FIGS. 11A and 11B, FIG. 12, and FIGS. 13A to 13C.

FIGS. 9A and 9B are external views of a battery pack. The battery pack includes a secondary battery 913 and a circuit board 900. The secondary battery 913 is connected to an antenna 914 through the circuit board 900. A label 910 is attached to the secondary battery 913. In addition, as illustrated in FIG. 9B, the secondary battery 913 is connected to a terminal 951 and a terminal 952. The circuit board 900 is fixed by a sealant 915.

The circuit board 900 includes a terminal 911 and a circuit 912. The terminal 911 is connected to the terminals 951 and 952, the antenna 914, and the circuit 912. Note that a plurality of terminals 911 may be provided to serve separately as a control signal input terminal, a power supply terminal, and the like.

The circuit 912 may be provided on the rear surface of the circuit board 900. Note that the shape of the antenna 914 is not limited to a coil shape and may be a linear shape or a plate shape. Furthermore, a planar antenna, an aperture antenna, a traveling-wave antenna, an EH antenna, a magnetic-field antenna, a dielectric antenna, or the like may be used. Alternatively, the antenna 914 may be a flat-plate conductor. The flat-plate conductor can serve as one of conductors for electric field coupling. That is, the antenna 914 can serve as one of two conductors of a capacitor. Thus, electric power can be transmitted and received not only by an electromagnetic field or a magnetic field but also by an electric field.

The battery pack includes a layer 916 between the secondary battery 913 and the antenna 914. The layer 916 has a function of blocking an electromagnetic field from the secondary battery 913, for example. As the layer 916, for example, a magnetic body can be used.

Note that the structure of the battery pack is not limited to that shown in FIGS. 9A and 9B.

For example, as shown in FIGS. 10A1 and 10A2, two opposite surfaces of the secondary battery 913 in FIGS. 9A and 9B may be provided with respective antennas. FIG. 10A1 is an external view illustrating one of the two surfaces, and FIG. 10A2 is an external view illustrating the other of the two surfaces. For portions identical to those in FIGS. 9A and 9B, the description of the secondary battery illustrated in FIGS. 9A and 9B can be referred to as appropriate.

As illustrated in FIG. 10A1, the antenna 914 is provided on one of the opposite surfaces of the secondary battery 913 with the layer 916 located therebetween. As illustrated in FIG. 10A2, an antenna 918 is provided on the other of the opposite surfaces of the secondary battery 913 with a layer 917 located therebetween. The layer 917 has a function of blocking an electromagnetic field from the secondary battery 913, for example. As the layer 917, for example, a magnetic body can be used.

With the above structure, both of the antennas 914 and 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as near field communication (NFC), can be employed.

Alternatively, as illustrated in FIG. 10B1, the secondary battery 913 in FIGS. 9A and 9B may be provided with a display device 920. The display device 920 is electrically connected to the terminal 911. Note that the label 910 is not necessarily provided in a portion where the display device 920 is provided. For portions identical to those in FIGS. 9A and 9B, the description of the secondary battery illustrated in FIGS. 9A and 9B can be referred to as appropriate.

The display device 920 can display, for example, an image showing whether charging is being carried out, an image showing the amount of stored power, or the like. As the display device 920, electronic paper, a liquid crystal display device, or an electroluminescent (EL) display device can be used, for instance. For example, the use of electronic paper can reduce power consumption of the display device 920.

Alternatively, as illustrated in FIG. 10B2, the secondary battery 913 in FIGS. 9A and 9B may be provided with a sensor 921. The sensor 921 is electrically connected to the terminal 911 via a terminal 922. For portions identical to those in FIGS. 9A and 9B, the description of the secondary battery illustrated in FIGS. 9A and 9B can be referred to as appropriate.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment where the secondary battery is placed (e.g., temperature) can be acquired and stored in a memory inside the circuit 912.

Another structure example of the secondary battery 913 is described with reference to FIGS. 11A and 11B and FIG. 12.

The secondary battery 913 illustrated in FIG. 11A includes a wound body 950 provided with the terminals 951 and 952 inside a housing 930. The wound body 950 is immersed in an electrolyte solution inside the housing 930. The terminal 952 is in contact with the housing 930. An insulator or the like inhibits contact between the terminal 951 and the housing 930. Note that in FIG. 11A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 11B, the housing 930 in FIG. 11A may be formed using a plurality of materials. For example, in the secondary battery 913 in FIG. 11B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna such as the antenna 914 may be provided inside the housing 930a. For the housing 930b, a metal material can be used, for example.

FIG. 12 illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

The negative electrode 931 is connected to the terminal 911 in FIGS. 9A and 9B via one of the terminals 951 and 952. The positive electrode 932 is connected to the terminal 911 in FIGS. 9A and 9B via the other of the terminals 951 and 952.

When the positive electrode described in the above embodiment is used as the positive electrode 932, the secondary battery 913 having excellent rate characteristics can be manufactured at a low cost.

### <Laminated Secondary Battery>

Next, examples of a laminated secondary battery will be described with reference to FIGS. 13A to 13C, FIGS. 14A and 14B, FIG. 15, FIG. 16, and FIGS. 17A to 17C. When a laminated secondary battery has flexibility and is used in an electronic device at least part of which is flexible, the secondary battery can be bent accordingly as the electronic device is bent.

A laminated secondary battery 980 is described with reference to FIGS. 13A to 13C. The laminated secondary battery 980 includes a wound body 993 illustrated in FIG. 13A. The wound body 993 includes a negative electrode 994, a positive electrode 995, and separators 996. The wound body 993 is, like the wound body 950 illustrated in FIG. 12, obtained by winding a sheet of a stack in which the negative electrode 994 and the positive electrode 995 overlap with the separator 996 therebetween.

Note that the number of stacks each including the negative electrode 994, the positive electrode 995, and the separator 996 can be determined as appropriate depending on required capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 13B, the wound body 993 is packed in a space formed by bonding a film 981 and a film 982 having a depressed portion by thermocompression bonding or the like, whereby the secondary battery 980 can be formed as illustrated in FIG. 13C. Note that the film 981 and the film 982 serve as an exterior body. The wound body 993 includes the lead electrode 997 and the lead electrode 998, and is immersed in an electrolyte solution inside a space surrounded by the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be manufactured.

Although FIGS. 13B and 13C illustrate an example in which a space is formed by the two films, the wound body 993 may be placed in a space formed by bending one film.

When the positive electrode described in the above embodiment is used as the positive electrode 995, the secondary battery 980 having excellent rate characteristics can be manufactured at a low cost.

FIGS. 13A to 13C shows an example of the secondary battery 980 including a wound body in a space formed by films serving as an exterior body; alternatively, as illustrated in FIGS. 14A and 14B, a secondary battery may include a plurality of strip-shaped positive electrodes, a plurality of strip-shaped separators, and a plurality of strip-shaped negative electrodes in a space formed by films serving as an exterior body, for example.

A laminated secondary battery 500 illustrated in FIG. 14A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The inside of the exterior body 509 is filled with the electrolyte solution 508. The electrolyte solution described in the above embodiment can be used as the electrolyte solution 508.

In the laminated secondary battery 500 illustrated in FIG. 14A, the positive electrode current collector 501 and the negative electrode current collector 504 also serve as terminals for obtaining electrical contact with the outside. For this reason, the positive electrode current collector 501 and the negative electrode current collector 504 may be arranged to be partly exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

As the exterior body 509 in the laminated secondary battery 500, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body can be used, for example.

FIG. 14B illustrates an example of a cross-sectional structure of the laminated secondary battery 500. Although FIG. 14A illustrates an example in which two current collectors are included for simplicity, an actual battery includes a plurality of electrode layers as illustrated in FIG. 14B.

The example in FIG. 14B includes 16 electrode layers. The laminated secondary battery 500 has flexibility even though including 16 electrode layers. FIG. 14B illustrates a structure including eight layers of negative electrode current collectors 504 and eight layers of positive electrode current collectors 501, i.e., 16 layers in total. Note that FIG. 14B illustrates a cross section of the lead portion of the negative electrode, and the eight negative electrode current collectors 504 are bonded to each other by ultrasonic welding. It is needless to say that the number of electrode layers is not limited to 16 and may be more than 16 or less than 16. With a large number of electrode layers, the secondary battery can have high capacity. By contrast, with a small number of electrode layers, the secondary battery can have small thickness and high flexibility.

FIG. 15 and FIG. 16 illustrate examples of an external view of the laminated secondary battery 500. FIG. 15 and FIG. 16 illustrate the positive electrode 503, the negative electrode 506, the separator 507, the exterior body 509, a positive electrode lead electrode 510, and a negative electrode lead electrode 511.

FIG. 17A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those in the example illustrated in FIG. 17A.

### <Method for Manufacturing Laminated Secondary Battery>

Here, an example of a method for manufacturing the laminated secondary battery whose external view is illustrated in FIG. 15 will be described with reference to FIGS. 17B and 17C.

First, the negative electrode 506, the separator 507, and the positive electrode 503 are stacked. FIG. 17B illustrates the stacked negative electrodes 506, separators 507, and positive electrodes 503. The secondary battery described here as an example includes five negative electrodes and four positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

Then, the negative electrodes 506, the separators 507, and the positive electrodes 503 are placed over the exterior body 509.

Subsequently, the exterior body 509 is folded along a dashed line as illustrated in FIG. 17C. Then, the outer edges of the exterior body 509 are bonded to each other. The bonding can be performed by thermocompression, for example. At this time, a part (or one side) of the exterior body 509 is left unbonded (to provide an inlet) so that the electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert atmosphere. Lastly, the inlet is sealed by bonding. In this manner, the laminated secondary battery 500 can be manufactured.

When the positive electrode described in the above embodiment is used as the positive electrode 503, the secondary battery 500 having excellent rate characteristics can be manufactured at a low cost.

This embodiment can be implemented in appropriate combination with any of the other embodiments.

### Embodiment 4

In this embodiment, examples of electronic devices each including the secondary battery of one embodiment of the present invention will be described.

FIGS. 18A to 18F show examples of electronic devices including the secondary battery described in the above embodiment. Examples of electronic devices including the secondary battery described in the above embodiment include television sets (also referred to as televisions or television receivers), monitors of computers and the like, digital cameras and digital video cameras, digital photo frames, mobile phones (also referred to as cellular phones or mobile phone devices), portable game machines, portable information terminals, portable batteries, audio reproducing devices, and large game machines such as pachinko machines.

FIG. 18A illustrates an example of a mobile phone. A mobile phone 7400 is provided with a display portion 7402 incorporated in a housing 7401, operation buttons 7403, an external connection port 7404, a speaker 7405, a microphone 7406, and the like. The mobile phone 7400 includes a secondary battery 7407. By using the secondary battery of one embodiment of the present invention as the secondary battery 7407, a high-performance mobile phone can be provided at a low cost.

FIG. 18B illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, mutual communication between the portable information terminal 7200 and a headset capable of wireless communication can be performed, and thus hands-free calling is possible.

Moreover, the portable information terminal 7200 includes the input/output terminal 7206, and data can be directly transmitted to and received from another information terminal via a connector. In addition, charging via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. With the use of the secondary battery of one embodiment of the present invention, a high-performance portable information terminal can be provided at a low cost. For example, the secondary battery 7104 in FIG. 18D that is in the state of being curved can be provided in the housing 7201. Alternatively, the secondary battery 7104 in FIG. 18D can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 18C illustrates an example of a bangle-type display device. A portable display device 7100 includes a housing 7101, a display portion 7102, operation buttons 7103, and a secondary battery 7104. FIG. 18D illustrates the secondary battery 7104 that is being bent. When the display device is worn on a user's arm while the secondary battery 7104 is bent, the housing changes its shape and the curvature of part or the whole of the secondary battery 7104 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is deformed with a radius of curvature in the range of 40 mm to 150 mm. When the radius of curvature of the main surface of the secondary battery 7104 ranges from 40 mm to 150 mm, the reliability can be kept high. By using the secondary battery of one embodiment of the present invention as the secondary battery 7104, a high-performance portable display device can be provided at a low cost.

FIG. 18E illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charging via the input/output terminal is possible. Note that the charging operation may be performed by wireless power feeding without using the input/output terminal.

By using the secondary battery of one embodiment of the present invention as the secondary battery included in the display device 7300, a high-performance display device can be provided at a low cost.

FIG. 18F illustrates an example of a mobile battery. A mobile battery 7350 includes a secondary battery and a plurality of terminals 7351. Another electronic device can be charged through the terminal 7351. By using the secondary battery of one embodiment of the present invention as the secondary battery included in the mobile battery 7350, the mobile battery 7350 can have high performance at a low cost.

Examples of electronic devices each including the secondary battery with excellent cycle performance described in the above embodiment will be described with reference to FIG. 18G, FIGS. 19A to 19C, and FIG. 20.

By using the secondary battery of one embodiment of the present invention as a secondary battery of an electronic device, a lightweight long-life product can be provided. Examples of electronic devices include an electric toothbrush, an electric shaver, and electric beauty equipment. As secondary batteries for these products, small and lightweight stick-type secondary batteries with high capacity are desired in consideration of handling ease for users.

FIG. 18G is a perspective view of a device called a vaporizer (electronic cigarette). In FIG. 18G, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharging and overdischarging of the secondary battery 7504 may be electrically connected to the secondary battery 7504. The secondary battery 7504 in FIG. 18G includes an external terminal for connection to a charger. When the electronic cigarette 7500 is held by a user, the secondary battery 7504 is at the tip of the device; thus, it is preferred that the secondary battery 7504 have a short total length and be lightweight. With the secondary battery of one embodiment of the present invention, which is inexpensive and has favorable rate characteristics, the electronic cigarette 7500 having favorable heating characteristics can be provided at a low cost.

FIGS. 19A and 19B illustrate an example of a tablet terminal that can be folded in half. A tablet terminal 9600 illustrated in FIGS. 19A and 19B includes a housing 9630a, a housing 9630b, a movable portion 9640 connecting the housings 9630a and 9630b, a display portion 9631 including a display portion 9631a and a display portion 9631b, switches 9625 to 9627, a fastener 9629, and an operation switch 9628. The use of a flexible panel for the display portion 9631 achieves a tablet terminal with a larger display portion. FIG. 19A illustrates the tablet terminal 9600 that is opened, and FIG. 19B illustrates the tablet terminal 9600 that is closed.

The tablet terminal 9600 includes a power storage unit 9635 inside the housings 9630a and 9630b. The power storage unit 9635 is provided across the housings 9630a and 9630b, passing through the movable portion 9640.

Part of or the entire display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text and an image is displayed on the display portion 9631b on the housing 9630b side.

It is also possible that a keyboard is displayed on the display portion 9631b on the housing 9630b side, and data such as text or an image is displayed on the display portion 9631a on the housing 9630a side. Furthermore, a switching button for showing/hiding a keyboard on a touch panel may be displayed on the display portion 9631 so that the keyboard is displayed on the display portion 9631 by touching the button with a finger, a stylus, or the like.

In addition, touch input can be performed concurrently in a touch panel region in the display portion 9631a on the housing 9630a side and a touch panel region in the display portion 9631b on the housing 9630b side.

The switches 9625 to 9627 may function not only as an interface for operating the tablet terminal 9600 but also as an interface that can switch various functions. For example, at least one of the switches 9625 to 9627 may have a function of switching on/off of the tablet terminal 9600. For another example, at least one of the switches 9625 to 9627 may have a function of switching display between a portrait mode and a landscape mode and a function of switching display between monochrome display and color display. For another example, at least one of the switches 9625 to 9627 may have a function of adjusting the luminance of the display portion 9631. The luminance of the display portion 9631 can be optimized in accordance with the amount of external light in use of the tablet terminal 9600, which is detected by an optical sensor incorporated in the tablet terminal 9600. Note that in addition to the optical sensor, the tablet terminal may incorporate another sensing device such as a sensor for measuring inclination, like a gyroscope sensor or an acceleration sensor.

The display portion 9631a on the housing 9630a side and the display portion 9631b on the housing 9630b side have substantially the same display area in FIG. 19A; however, there is no particular limitation on the display areas of the display portions 9631a and 9631b, and the display portions may have different areas or different display quality. For example, one of the display portions 9631a and 9631b may display higher-definition images than the other.

The tablet terminal 9600 is folded in half in FIG. 19B. The tablet terminal 9600 includes a housing 9630, a solar cell 9633, and a charge/discharge control circuit 9634 including a DC-DC converter 9636. The power storage unit of one embodiment of the present invention is used as the power storage unit 9635.

As described above, the tablet terminal 9600 can be folded in half such that the housings 9630a and 9630b overlap each other when not in use. Accordingly, the display portion 9631 can be protected, which increases the durability of the tablet terminal 9600. With the power storage unit 9635 including the secondary battery of one embodiment of the present invention, which is inexpensive and has favorable rate characteristics, the tablet terminal 9600 can have high performance at a low cost.

The tablet terminal 9600 illustrated in FIGS. 19A and 19B can also have a function of displaying various kinds of data (e.g., a still image, a moving image, and a text image), a function of displaying a calendar, a date, the time, or the like on the display portion, a touch input function of operating or editing data displayed on the display portion by touch input, a function of controlling processing by various kinds of software (programs), and the like.

The solar cell 9633, which is attached on the surface of the tablet terminal 9600, supplies electric power to the touch panel, the display portion, a video signal processing portion, and the like. Note that the solar cell 9633 can be provided on one or both surfaces of the housing 9630, and the power storage unit 9635 can be charged efficiently. The use of a lithium-ion battery as the power storage unit 9635 brings an advantage such as a reduction in size.

The structure and operation of the charge/discharge control circuit 9634 illustrated in FIG. 19B will be described with reference to a block diagram in FIG. 19C. FIG. 19C illustrates the solar cell 9633, the power storage unit 9635, the DC-DC converter 9636, a converter 9637, switches SW1 to SW3, and the display portion 9631. The power storage unit 9635, the DC-DC converter 9636, the converter 9637, and the switches SW1 to SW3 correspond to the charge/discharge control circuit 9634 in FIG. 19B.

First, an operation example in which electric power is generated by the solar cell 9633 using external light is described. The voltage of electric power generated by the solar cell is raised or lowered by the DC-DC converter 9636 to a voltage for charging the power storage unit 9635. When the display portion 9631 operates with the electric power from the solar cell 9633, the switch SW1 is turned on and the voltage of the electric power is raised or lowered by the converter 9637 to a voltage needed for the display portion 9631. When display on the display portion 9631 is not performed, the switch SW1 is turned off and the switch SW2 is turned on, so that the power storage unit 9635 can be charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the power storage unit 9635 may be charged with a non-contact power transmission module that transmits and receives electric power wirelessly (without contact), or with a combination of other charging units.

FIG. 20 illustrates other examples of electronic devices. In FIG. 20, a display device 8000 is an example of an electronic device using a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can receive electric power from a commercial power supply. Alternatively, the display device 8000 can use electric power stored in the secondary battery 8004. Thus, the display device 8000 can operate with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all of information display devices for personal computers, advertisement displays, and the like besides TV broadcast reception.

In FIG. 20, an installation lighting device 8100 is an example of an electronic device using a secondary battery 8103 of one embodiment of the present invention. Specifically, the lighting device 8100 includes a housing 8101, a light source 8102, the secondary battery 8103, and the like. Although FIG. 20 illustrates the case where the secondary battery 8103 is provided in a ceiling 8104 on which the housing 8101 and the light source 8102 are installed, the secondary battery 8103 may be provided in the housing 8101. The lighting device 8100 can receive electric power from a commercial power supply. Alternatively, the lighting device 8100 can use electric power stored in the secondary battery 8103. Thus, the lighting device 8100 can operate with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated as an example in FIG. 20, the secondary battery of one embodiment of the present invention can be used in an installation lighting device provided in, for example, a wall 8105, a floor 8106, a window 8107, or the like other than the ceiling 8104. Alternatively, the secondary battery can be used in a tabletop lighting device or the like.

As the light source 8102, an artificial light source that emits light artificially by using electric power can be used. Specific examples of the artificial light source include an incandescent lamp, a discharge lamp such as a fluorescent lamp, and light-emitting elements such as an LED and an organic EL element.

In FIG. 20, an air conditioner including an indoor unit 8200 and an outdoor unit 8204 is an example of an electronic device using a secondary battery 8203 of one embodiment of the present invention. Specifically, the indoor unit 8200 includes a housing 8201, an air outlet 8202, the secondary battery 8203, and the like. Although FIG. 20 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply. Alternatively, the air conditioner can use electric power stored in the secondary battery 8203. Particularly in the case where the secondary batteries 8203 are provided in both the indoor unit 8200 and the outdoor unit 8204, the air conditioner can operate with the use of the secondary batteries 8203 of one embodiment of the present invention as uninterruptible power supplies even when electric power cannot be supplied from a commercial power supply due to power failure or the like.

Note that although the split-type air conditioner including the indoor unit and the outdoor unit is illustrated as an example in FIG. 20, the secondary battery of one embodiment of the present invention can also be used in an air conditioner in which the functions of an indoor unit and an outdoor unit are integrated in one housing.

In FIG. 20, an electric refrigerator-freezer 8300 is an example of an electronic device using a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided inside the housing 8301 in FIG. 20. The electric refrigerator-freezer 8300 can receive electric power from a commercial power supply. Alternatively, the electric refrigerator-freezer 8300 can use electric power stored in the secondary battery 8304. Thus, the electric refrigerator-freezer 8300 can operate with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. The tripping of a breaker of a commercial power supply in use of such an electronic device can be prevented by using the secondary battery of one embodiment of the present invention as an auxiliary power supply for supplying electric power which cannot be supplied enough by a commercial power supply.

In addition, by storing electric power in the secondary battery in a time period during which electronic devices are not used, particularly a time period during which the proportion of the amount of electric power that is actually used to the total amount of electric power that can be supplied from a commercial power supply source (such a proportion is referred to as an electricity usage rate) is low, the electricity usage rate can be reduced in a time period other than the above. For example, in the case of the electric refrigerator-freezer 8300, electric power is stored in the secondary battery 8304 in night time when the temperature is low and the refrigerator door 8302 and the freezer door 8303 are not often opened or closed. On the other hand, in daytime when the temperature is high and the refrigerator door 8302 and the freezer door 8303 are frequently opened and closed, the secondary battery 8304 is used as an auxiliary power supply; thus, the electricity usage rate in daytime can be reduced.

According to one embodiment of the present invention, the secondary battery can have excellent cycle performance and improved reliability. Moreover, according to one embodiment of the present invention, a secondary battery with high capacity can be obtained; hence, the secondary battery itself can be made more compact and lightweight as a result of improved characteristics of the secondary battery. Thus, the use of the secondary battery of one embodiment of the present invention enables the electronic device described in this embodiment to have higher performance at a lower cost.

This embodiment can be implemented in appropriate combination with any of the other embodiments.

### Embodiment 5

In this embodiment, examples of electronic devices provided with the secondary battery described in the above embodiment are described with reference to FIGS. 21A to 21C and FIGS. 22A to 22C.

FIG. 21A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 21A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, the glasses-type device 4000 can have high performance at a low cost.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b and the earphone portion 4001c. With the use of the secondary battery of one embodiment of the present invention, the headset-type device 4001 can have high performance at a low cost.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, the device 4002 can have high performance at a low cost.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, the device 4003 can have high performance at a low cost.

The secondary battery of one embodiment of the present invention can be provided in a belt-type device 4006. The belt-type device 4006 includes a display portion 4006a and a wireless power feeding and receiving portion 4006b, and the secondary battery can be provided inside the belt portion 4006a. With the use of the secondary battery of one embodiment of the present invention, the belt-type device 4006 can have high performance at a low cost.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, the watch-type device 4005 can have high performance at a low cost.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 21B is a perspective view of the watch-type device 4005 that is attached from an arm.

FIG. 21C is a side view. FIG. 21C illustrates a state where the secondary battery 913 is incorporated in the watch-type device 4005. The secondary battery 913 is the secondary battery described in Embodiment 3. The secondary battery 913, which is small and lightweight, overlaps with the display portion 4005a.

FIG. 22A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery of one embodiment of the present invention can be a high-performance electronic device at a low cost.

FIG. 22B illustrates an example of a robot. A robot 6400 illustrated in FIG. 22B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention or the electronic component can be a high-performance electronic device at a low cost.

FIG. 22C illustrates an example of a flying object. A flying object 6500 illustrated in FIG. 22C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The secondary battery of one embodiment of the present invention has favorable rate characteristics and outputs high power; thus, when the secondary battery is included in the flying object 6500, the flying object 6500 can have high acceleration performance or the like.

This embodiment can be implemented in appropriate combination with any of the other embodiments.

### Embodiment 6

In this embodiment, examples of vehicles each including the secondary battery of one embodiment of the present invention will be described.

The use of secondary batteries in vehicles enables production of next-generation clean energy vehicles such as hybrid electric vehicles (HV), electric vehicles (EV), and plug-in hybrid electric vehicles (PEV).

FIGS. 23A to 23C each illustrate an example of a vehicle including the secondary battery of one embodiment of the present invention. An automobile 8400 illustrated in FIG. 23A is an electric vehicle that runs on the power of an electric motor. Alternatively, the automobile 8400 is a hybrid electric vehicle capable of driving using either an electric motor or an engine as appropriate. The use of one embodiment of the present invention allows fabrication of a high-mileage vehicle. The automobile 8400 includes the secondary battery. As the secondary battery, the modules of the secondary batteries illustrated in FIGS. 8C and 8D can be arranged to be used in a floor portion in the automobile. Alternatively, a battery pack in which a plurality of secondary batteries each of which is illustrated in FIGS. 11A and 11B are combined may be placed in the floor portion in the automobile. The secondary battery is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 23B illustrates an automobile 8500 including the secondary battery. The automobile 8500 can be charged when the secondary battery is supplied with electric power through external charging equipment by a plug-in system, a contactless power feeding system, or the like. In FIG. 23B, a secondary battery 8024 and a secondary battery 8025 included in the automobile 8500 are charged with the use of a ground-based charging apparatus 8021 through a cable 8022. In charging, a given method such as CHAdeMO (registered trademark) or Combined Charging System can be employed as a charging method, the standard of a connector, or the like as appropriate. The charging apparatus 8021 may be a charging station provided in a commerce facility or a power source in a house. For example, with the use of a plug-in technique, the secondary battery 8024 and a secondary battery 8025 included in the automobile 8500 can be charged by being supplied with electric power from outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 23C shows an example of a motorcycle including the secondary battery of one embodiment of the present invention. A motor scooter 8600 illustrated in FIG. 23C includes a secondary battery 8602, side mirrors 8601, and indicators 8603. The secondary battery 8602 can supply electric power to the indicators 8603.

In the motor scooter 8600 illustrated in FIG. 23C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors when charged, and is stored before the motor scooter is driven.

According to one embodiment of the present invention, the productivity of the secondary battery having favorable rate characteristics and outputting high power can be increased. Thus, when the secondary battery of one embodiment of the present invention is included in a vehicle, the vehicle can have high acceleration performance or the like. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with favorable cycle performance can be used over a long period; thus, the use amount of rare metals such as cobalt can be reduced.

This embodiment can be implemented in appropriate combination with any of the other embodiments.

### Example 1

In this example, a reduction method of GO was examined. For the examination, GO films for fundamental evaluation were formed, reduced by several methods, and subjected to various analyses.

### <Fabrication of GO Film>

As GO, GO formed by using potassium permanganate and sulfuric acid in an oxidation step by the modified Hummers method was used. Added was 600 ml of water to 200 ml of dispersion liquid in which 3 wt % GO was dispersed in water, and stirring was performed for 12 hours with a stirrer at 600 rpm, so that dispersion liquid A was formed.

Next, graphene compound sheets (GO films) were formed using GO dispersion liquid as a raw material by a spray dry method. Here, the GO films were formed on a wall surface of a chamber of a spray dry apparatus. The following shows details.

As the spray dry apparatus, a mini spray dryer B-290 manufactured by Nihon BUCHI K.K. was used. An inlet was set to 160° C. It is considered that a nozzle and the vicinity thereof were heated to a temperature higher than or equal to 100° C. The dispersion liquid A was supplied to the nozzle of the spray dry apparatus at a rate of approximately 65 ml/min. The dispersion liquid A was supplied from the nozzle to the chamber in the form of mist together with a nitrogen gas at a flow rate of 12 L/min.

Part of the dispersion liquid A supplied to the chamber in the form of mist was collected to a collection container as powder of the GO, and other parts were formed as GO films on an inner wall of a wall of a cylindrical chamber.

Next, the GO films were peeled from the inner wall of the chamber. The GO film indicated by the arrow in FIG. 24 was obtained. The GO films each include a plurality of sheets of GO overlapping with each other. The average thickness of the GO film was 8.6 μm. The GO film before reduction was Sample 1 (Comparative example).

### <Chemical Reduction>

Next, the GO films were reduced by a chemical method. Ascorbic acid was used as a reducing agent. Formed was 0.078 mol/L of an L-ascorbic acid solution and the GO films were immersed therein. Then, the mixture was reacted at 60° C. for one hour (h). One of the chemically reduced GO films was Sample 2.

### <Thermal Reduction>

Then, the other GO films were reduced by a thermal method. A glass tube oven was used for heating. The heating temperatures were 100° C., 120° C., 150° C., 170° C., 200° C., and 250° C. The heating time was 10 hours. Note that at 170° C., a sample heated for one hour was also fabricated. The heating time included time for raising the temperature. The temperature rising rate was approximately 11° C./min. The heating was performed under a reduced pressure (approximately 1 kPa) at all the heating temperatures. The thermally reduced GO films were Samples 3 to 9.

A GO film was subjected to chemical reduction using the ascorbic acid solution at 60° C. for one hour and then subjected to thermal reduction at 170° C. for 10 hours, whereby Sample 10 was obtained.

Table 1 shows the fabrication conditions of Samples 1 to 10.

TABLE 1

| Sample name | Reduction method |
|---|---|
| Sample 1 | No reduction |
| (Comparative example) | |
| Sample 2 | Chemical reduction |
| | (60° C. ascorbic acid solution, 1 h) |
| Sample 3 | Thermal reduction (100° C., 10 h) |
| Sample 4 | Thermal reduction (125° C., 10 h) |
| Sample 5 | Thermal reduction (150° C., 10 h) |
| Sample 6 | Thermal reduction (170° C., 10 h) |
| Sample 7 | Thermal reduction (170° C., 1 h) |
| Sample 8 | Thermal reduction (200° C., 10 h) |
| Sample 9 | Thermal reduction (250° C., 10 h) |
| Sample 10 | Chemical reduction |
| | (60° C. ascorbic acid solution, 1 h) ⇒ |
| | Thermal reduction (170° C., 10 h) |

### <Raman Spectroscopy>

Samples 1, 7, and 10 fabricated in the above-described manner were analyzed by Raman spectroscopy. A laser wavelength was 532 nm, chromatic dispersion D was 0.6, the diameter of a pinhole was 100 μm, the center wave number of a spectrometer was 2000 cm⁻¹, the size of a diffraction grating was 150 nm to 500 nm, light exposure time was 10 seconds, and addition was performed five times. The samples were measured while being fixed to a glass plate with a double-faced tape.

FIG. 25 shows Raman spectra. A G band (peak derived from sp² hybrid orbitals) appears at around 1590 cm⁻¹. A D band (peak derived from spa hybrid orbitals) appears at around 1350 cm⁻¹.

As shown in FIG. 25, Sample 7 subjected to only thermal reduction has a slightly higher G band peak intensity and a broader D band peak than non-reduced Sample 1. Thus, it was suggested that both sp² hybrid orbitals and defects increased.

In contrast, Sample 10 subjected to both chemical reduction and thermal reduction has a higher G band peak intensity than Sample 1. Thus, it was suggested that sp² hybrid orbitals increased.

The intensity ratios of the G band to the D band (G/D) were 0.936, 1.06, and 1.63 in Sample 1, Sample 5, and Sample 10, respectively.

### <FT-IR and XRD (Reduction Temperature)>

Next, Sample 1, which is a comparative example, and Samples 3, 4, 5, 6, and 9 thermally reduced at different temperatures were compared by analysis by Fourier transform infrared spectroscopy (FT-IR) and XRD. In FT-IR, attenuated total reflection (ATR) was performed.

FIG. 26 shows the FT-IR results. In FT-IR, absorption derived from a hydroxy group (O—H) appears at a wave number of greater than or equal to 3000 cm⁻¹ and less than or equal to 3600 cm⁻¹. Absorption derived from a carbonyl group (C═O) appears at a wave number of around 1720 cm⁻¹. Absorption derived from a carbon double bond (C═C) appears at a wave number of around 1640 cm⁻¹. Absorption derived from a carbon-oxygen bond (C—O) appears at a wave number of around 1050 cm⁻¹. These are shown as gray portions in FIG. 26.

As shown in FIG. 26, the higher the reduction temperature is, the smaller a decrease in the absorption that is derived from O—H and appears at a wave number greater than or equal to 3000 cm⁻¹ and less than or equal to 3600 cm⁻¹ and the absorption that is derived from C—O and appears at a wave number of around 1050 cm⁻¹ is, which suggests release of the hydroxy group. An increase in the absorption that is derived from C═C and appears at a wave number of around 1640 cm⁻¹ suggests an increase in the carbon double bond (C═C).

FIG. 27 shows the XRD results. As XRD, X-ray powder diffraction using CuKα1 radiation was performed in the air. An electrode was attached to a silicon non-reflective plate with grease to maintain flatness. A broad peak at approximately 2θ=19° in XRD is background. Graphite has a peak derived from interlayer distance at around 2θ=25°.

As shown in FIG. 27, non-reduced Sample 1 and Sample 3 reduced at 100° C. each had a peak at approximately 2θ=10° to 12°. Meanwhile, Samples 4, 5, 6, and 9 thermally reduced at 125° C. or higher each had a peak at around 2θ=24°, which is close to a peak of graphite derived from interlayer distance.

These results show that thermal reduction proceeds as the temperature is raised. It was also found that thermal reduction at 125° C. or higher significantly proceeds.

### <Sheet Resistance>

Next, the surface resistivities of Samples 1, 2, 6, and 10 were measured. The measurement was performed by a four-terminal four-probe method. FIG. 28 shows results.

As shown in FIG. 28, Samples 2, 6, and 10 subjected to some sort of reduction treatment had improved conductivity compared to non-reduced Sample 1. Thermally reduced Sample 6 had a lower surface resistivity compared to chemically reduced Sample 2. Thus, it was suggested that thermal reduction makes a larger contribution to a reduction in resistance than chemical reduction using ascorbic acid.

### <XRD (Reduction Method)>

Next, Sample 1 and Samples 2, 6, and 10 reduced by different methods were compared by analysis by XRD as in FIG. 27. FIG. 29 shows results. A broad peak at approximately 2θ=19° denoted by asterisk in FIG. 29 is background. A peak at around 2θ=25° denoted by a dotted line in FIG. 29 is derived from the interlayer distance of graphite.

Table 2 lists the results of calculating the distance between carbon sheets of each sample using the Bragg equation from the position of a peak derived from a (002) plane in the XRD spectra shown in FIG. 29. The surface resistivities measured above are also listed.

TABLE 2

| | Sample 1 | Sample 2 | Sample 6 | Sample 10 |
|---|---|---|---|---|
| Resistivity [Ω/square] | 7.6 × 10⁶ | 9.1 × 10³ | 4.9 × 10¹ | 2.7 × 10¹ |
| Interlayer distance [nm] | 0.87 | 0.82 | 0.37 | 0.36 |

According to FIG. 29 and Table 2, Sample 10 subjected to both chemical reduction and thermal reduction had the lowest resistivity and the shortest interlayer distance. Thermally reduced Sample 6 had a lower resistivity and a shorter interlayer distance than Sample 2 subjected to only chemical reduction. These results show that the shorter the distance between carbon sheets is, the lower the resistance becomes.

### <FT-IR (Reduction Method)>

Next, Sample 1 and Samples 2, 6, and 10 reduced by different methods were compared by analysis by FT-IR as in FIG. 26. FIG. 30 shows results. As in FIG. 26, absorptions of functional groups are shown as gray portions in the drawing.

As shown in FIG. 30, Sample 10 subjected to both chemical reduction and thermal reduction has absorption at a wave number of around 1640 cm⁻¹, which means that C═C is generated. In addition, in thermally reduced Samples 6 and 10, the absorptions at a wave number of around 1050 cm⁻¹ and at a wave number of greater than or equal to 3000 cm⁻¹ and less than or equal to 3600 cm⁻¹ decrease, which means that the hydroxy group (—OH) was released from carbon. The absorption at a wave number of around 1720 cm⁻¹ decreases in chemically reduced Samples 2 and 10, which means that the carbonyl group (C═O) and the carboxy group (—COOH) were reduced.

### <XPS>

Then, powdery GOs, which were not made into GO films, were subjected to reduction treatments similar to those for Samples 1, 2, 8, and 10, and then analyzed by XPS. Table 3 shows results.

TABLE 3

| | C1s waveform analysis (%) | | | | | | | | | |
|---|---|---|---|---|---|---|---|---|---|---|
| | | C—C | | | | | | | | |
| | C═C | C—H | | | | Quantitative values of elements (atomic %) | | | | |
| Sample name | (sp²) | (sp³) | C—O | C═O | O═C—O | C | O | N | S | Si |
| Sample 1 | 0 | 37 | 51.4 | 8.3 | 3.3 | 64.1 | 34 | 0.6 | 1.3 | 0 |
| Sample 2 | 74.6 | 11.8 | 8.1 | 3.8 | 1.7 | 88.9 | 10.3 | 0.8 | 0 | 0 |
| Sample 8 | 51 | 26.7 | 12.4 | 5.7 | 4.3 | 82.1 | 12.7 | 5 | 0.2 | 0 |
| Sample 10 | 77.3 | 13.8 | 5.2 | 2.4 | 1.3 | 91.0 | 7.9 | 0.3 | 0 | 0.8 |

As shown in Table 3, the proportion of C—O decreases in chemically reduced Sample 2, which means that an epoxy group or the carboxy group was reduced. Although it can be considered that C—O is derived from the hydroxy group, according to the FT-IR results, C—O is probably not sufficiently reduced in Sample 2. Moreover, the carbon double bond (C═C) increased compared to that in Sample 7 subjected to only thermal reduction.

The above analysis revealed that chemical reduction by protonation using a reducing agent is effective in reducing a carbonyl group (C═O) and a carboxy group (—COOH) in GO. It was also revealed that thermal reduction by dehydration is effective in reducing a hydroxy group (—OH) in GO. The interlayer distance of GO is reduced with the progress of reduction, which improves conductivity.

As described above, it was found that GO subjected to both chemical reduction and thermal reduction can be reduced more efficiently and has improved conductivity. Chemical reduction can be performed at a lower temperature than thermal reduction. Therefore, chemical reduction is effective in the case where a positive electrode material has a low heat resistance, for example.

### Example 2

In this example, secondary batteries each using chemically or thermally reduced GO as a conductive material were fabricated, and characteristics thereof were evaluated.

### <Fabrication of Secondary Battery>

For evaluation, CR2032 coin-type secondary batteries (with a diameter of 20 mm and a height of 3.2 mm) were fabricated.

As a positive electrode active material of each secondary battery, LFP was used. As a conductive material to be reduced in a later step, GO (produced by NiSiNa materials Co., Ltd., a Modified Hummers method was employed in an oxidation step) was used. As a binder, PVDF was used. The positive electrode active material, the conductive material, and the binder were mixed at a ratio of 94.2:0.8:5 (wt %) to form slurry. As a solvent, NMP was used. The slurry was applied on a current collector and dried. As the current collector, an aluminum foil with a carbon undercoat was used.

Next, the GO in a positive electrode active material layer was chemically or thermally reduced.

As a reducing agent for chemical reduction, L-ascorbic acid was used. As a solvent, 0.078 mol/L of an L-ascorbic acid solution was formed by mixing water and NMP at a volume ratio of 1:9. The current collector coated with the positive electrode active material layer was immersed in the L-ascorbic acid solution and reacted at 60° C. for one hour. The resulting sample was used for Sample 11. The reduction conditions were the same as those for Sample 2 in Example 1.

Sample 12 was obtained in such a manner that thermal reduction was performed at 170° C. for 10 hours. The reduction conditions were the same as those for Sample 6.

Sample 13 was obtained in such a manner that chemical reduction by immersion in 0.078 mol/L of the L-ascorbic acid solution and reaction at 60° C. for one hour was performed and then thermal reduction at 170° C. for 10 hours was performed. The reduction conditions were the same as those for Sample 10.

After each reduction treatment, application of linear pressure at 210 kN/m was performed, whereby positive electrodes were formed.

As comparative examples, Sample 14 using AB as the conductive material and including the positive electrode active material, the conductive material, and the binder at a ratio of 94.2:0.8:5 (wt %), Sample 15 using AB as the conductive material and including the positive electrode active material, the conductive material, and the binder at a ratio of 85:10:5 (wt %), and Sample 16 using graphene (grade A-12, produced by Graphene Supermarket) as the conductive material and including the positive electrode active material, the conductive material, and the binder at a ratio of 85:10:5 (wt %) were formed. The graphene used for Sample 16 has not been undergone an oxidation step. The fabrication conditions of the samples were similar to those for Samples 11 to 13 except for the material of the conductive material and the mixing ratio of the materials of the positive electrode active material layer.

A lithium metal was used for a counter electrode.

As an electrolyte contained in each electrolytic solution, 1 mol/L lithium hexafluorophosphate (LiPF₆) was used, and as the electrolytic solution, a solution in which ethylene carbonate (EC) and diethyl carbonate (DEC) were mixed at a volume ratio of 3:7 was used.

As a separator, 25-μm-thick polypropylene was used.

A positive electrode can and a negative electrode can that were formed of stainless steel (SUS) were used.

Table 4 shows the fabrication conditions of Samples 11 to 16.

TABLE 4

| | | Composition proportion (wt %) | | | Electrode | |
|---|---|---|---|---|---|---|
| Secondary | | Active | | | Carried | |
| battery | Conductive | material | Conductive | Binder | amount | Density |
| sample | material | (LFP) | material | (PVDF) | (mg/cm²) | (g/cm³) |
| Sample 11 | Chemically | 94.2 | 0.8 | 5 | 8.6 | 1.91 |
| | reduced GO | | | | | |
| Sample 12 | Thermally | 94.2 | 0.8 | 5 | 9.1 | 2.06 |
| | reduced GO | | | | | |
| Sample 13 | Chemically | 94.2 | 0.8 | 5 | 9 | 2.05 |
| | and then | | | | | |
| | thermally | | | | | |
| | reduced GO | | | | | |
| Sample 14 | AB | 94.2 | 0.8 | 5 | 10.5 | 2.02 |
| (Comparative | | | | | | |
| example) | | | | | | |
| Sample 15 | AB | 85 | 10 | 5 | 9 | 1.72 |
| (Comparative | | | | | | |
| example) | | | | | | |
| Sample 16 | Graphene | 85 | 10 | 5 | 8.9 | 1.83 |
| (Comparative | | | | | | |
| example) | | | | | | |

### <SEM>

The positive electrode of Sample 13 fabricated above was observed with an electron microscope. FIG. 31 shows a surface SEM image and FIG. 32A shows a cross-sectional SEM image. Parts of RGO observed as white lines in FIG. 32A are traced by black lines in FIG. 32B for easy understanding.

According to FIG. 31, the RGO covers a plurality of positive electrode active material particles. According to FIGS. 32A and 32B, the RGO is not aggregated and favorably dispersed in the positive electrode active material layer. It can be said that the RGO is distributed in a net-like shape or forms a net-like structure. The net-like structure is formed of the RGO, and thus is also referred to as a graphene net.

### <Battery Characteristics>

Next, Samples 11 to 16 were subjected to a charge and discharge test. As the measurement, the CCCV charging (0.2 C, 4.3 V, a termination current of 0.02 C) and the CC discharging (0.2 C, a termination voltage of 2.0 V) were performed at 25° C. Note that 1 C was 170 mA/g in this example and the like.

FIG. 33A shows the initial discharge curves of Samples 11 to 13 each using RGO as the conductive material. Initial discharge capacities of Samples 11, 12, and 13 were 55 mAh/g, 156 mAh/g, and 158 mAh/g, respectively. In particular, chemically and thermally reduced Sample 13 had favorable discharge characteristics including a wide plateau. It was found that a combination of the reduction methods reduced the resistance of the GO.

Next, Sample 13 was subjected to a cycle test while a discharge rate was changed: 0.2 C discharge in first to 10th cycles; 0.5 C discharge in 11th to 20th cycles; 1 C discharge in 21st to 30th cycles; and 0.2 C discharge in 31st and 32nd cycles. Other conditions were similar to those of the above-described charge and discharge test.

FIG. 33B shows the discharge capacity of Sample 13. It was found that Sample 13 using chemically and thermally reduced GO shows favorable battery characteristics even when the discharge rate is increased.

FIGS. 34A and 34B show the initial charge and discharge curves of Samples 13 to 16. FIG. 34A shows the discharge capacity per weight of the active material, and FIG. 34B shows the discharge capacity per volume of the positive electrode active material layer.

Sample 13 using 0.8 wt % RGO as the conductive material shows favorable discharge characteristics although the amount of conductive material is much smaller than that of Sample 15. It was suggested that 0.8 wt % RGO can form a sufficient conductive path in the positive electrode active material layer. The discharge capacity of Sample 13 was 158 mAh/g per weight of the active material and 304 mAh/cm³ per volume of the positive electrode active material layer.

In contrast, Sample 14 using 0.8 wt % AB as the conductive material had a discharge capacity lower than or equal to 1 mAh/g and a discharge capacity of 1 mAh/cm³, and hardly functioned as a battery. It was suggested that 0.8 wt % AB cannot form a conductive path.

Sample 15 using 10 wt % AB as the conductive material showed relatively favorable discharge characteristics, which suggests that a conductive path can be formed in the positive electrode active material layer. However, the discharge capacity of Sample 15 was 139 mAh/g per weight of the active material and 201 mAh/cm³ per volume of the positive electrode active material layer. In particular, the discharge capacity per volume of the positive electrode active material layer of Sample 15 was less than or equal to two thirds of that of Sample 14. It was found that when 10 wt % AB is used as the conductive material, the discharge capacity per weight of the active material and the discharge capacity per volume of the positive electrode active material layer decrease because the volume of the AB is large.

The discharge characteristics of Sample 16 using 10 wt % graphene were also as favorable as those of Sample 14, but were not comparable to those of Sample 13 using RGO. It was found that RGO is favorably dispersed and can efficiently form a conductive pass with a small amount compared to graphene.

Then, the rate characteristics of Samples 13 and 15 were compared. Measurement was performed at a discharge rate of 0.2 C, 0.5 C, 1 C, 2 C, and 5 C. Other conditions were similar to those of the above-described charge and discharge test.

FIGS. 35A and 35B show the discharge curves of Sample 13 and the discharge curves of Sample 15, respectively. The discharge capacity of Sample 13 was 158 mAh/g at 0.2 C, 153 mAh/g at 0.5 C, 149 mAh/g at 1 C, 143 mAh/g at 2 C, and 130 mAh/g at 5 C. The discharge capacity of Sample 15 was 139 mAh/g at 0.2 C, 127 mAh/g at 0.5 C, 118 mAh/g at 1 C, 107 mAh/g at 2 C, and 92 mAh/g at 5 C.

As described above, Sample 13 using 0.8 wt % RGO showed more favorable rate characteristics than Sample 15 using 10 wt % AB. Since RGO can make surface contact with a positive electrode active material particle, this property probably contributes to a reduction in the resistance of the secondary battery.

As described in the above example, the secondary battery using RGO as the conductive material was found to have favorable battery characteristics, for example, high energy density and high rate characteristics with a small amount of conductive material.

### Example 3

In this example, a secondary battery using RGO as a conductive material, a secondary battery using graphene as a conductive material, and a secondary battery using AB as a conductive material were fabricated, and the characteristics thereof were compared.

### <Fabrication of Secondary Battery>

For evaluation, CR2032 coin-type secondary batteries (with a diameter of 20 mm and a height of 3.2 mm) were fabricated.

As a positive electrode active material in the secondary battery, LFP or lithium nickel-cobalt-manganese oxide (NCM) was used. Note that LFP used in this example was synthesized by a solid phase method using lithium carbonate, ammonium dihydrogenphosphate, and iron oxalate dihydrate as raw materials. NCM having an atomic ratio of Ni:Co:Mn=5:2:3 (produced by MTI) was used. The NCM is referred to as NCM523 in some cases. For Samples 17 to 19, LFP was used, and for Samples 20 to 22, NCM523 was used.

As a conductive material, GO or AB was used. The GO is reduced in a later step. For Samples 17, 20, and 22, GO was used. For Sample 18, graphene (grade A-12, produced by Graphene Supermarket) was used. For Samples 19 and 21, AB was used.

As a binder, PVDF was used. The composition proportion of the binder in the total amount of the positive electrode active material, the conductive material, and the binder was set to 5 wt %.

The positive electrode active material, the conductive material, and the binder were mixed to form slurry. As a solvent, NMP was used. The slurry was applied on a current collector and dried. As the current collector, an aluminum foil with a carbon undercoat was used.

Next, Samples 17, 20, and 22 each using GO as the conductive material were subjected to chemical reduction and thermal reduction.

As a reducing agent for chemical reduction, L-ascorbic acid was used. As a solvent, 0.078 mol/L of an L-ascorbic acid solution was formed by mixing water and NMP at a volume ratio of 1:9. The current collector coated with a positive electrode active material layer was immersed in the L-ascorbic acid solution and reacted at 60° C. for one hour.

Next, thermal reduction was performed at 170° C. for 10 hours.

After the reduction treatment, application of linear pressure at 210 kN/m was performed, whereby positive electrodes were formed.

A lithium metal was used for a counter electrode.

As an electrolyte contained in the electrolytic solution, 1 mol/L lithium hexafluorophosphate (LiPF₆) was used. As the electrolytic solution, a solution in which ethylene carbonate (EC) and diethyl carbonate (DEC) were mixed at a volume ratio of 3:7 and 2 wt % vinylene carbonate (VC) was added thereto was used.

As a separator, 25-μm-thick polypropylene was used.

A positive electrode can and a negative electrode can that were formed of stainless steel (SUS) were used.

Table 5 shows the fabrication conditions of Samples 17 to 22.

TABLE 5

| | |
|---|---|
| Sample name | Fabrication conditions |

| | | |
|---|---|---|
| Sample 17 | LFP | GO |
| | (Solid phase method) | 0.8 wt % |
| Sample 18 | LFP | Graphene |
| (Comparative | (Solid phase method) | 10 wt % |
| example) | | |
| Sample 19 | LFP | AB |
| (Comparative | (Solid phase method) | 10 wt % |
| example) | | |
| Sample 20 | NCM523 | GO |
| | | 1 wt % |
| Sample 21 | NCM523 | AB |
| (Comparative | | 3 wt % |
| example) | | |
| Sample 22 | NCM523 | GO |
| | | 3 wt % |

### <Battery Characteristics>

Samples 17 to 22 were subjected to a charge and discharge test.

FIG. 36A shows the charge rate characteristics at 25° C. of Samples 17 to 19. The CC charging (0.2 C, 0.5 C 1 C, 2 C, or 5 C, a termination voltage of 4.3 V) and the CC discharging (0.2 C, a termination voltage of 2.0 V) were performed. Note that 1 C was set to 170 mA/g in this example and the like. FIG. 36B shows the discharge rate characteristics of Samples 17 to 19 at 25° C. The CCCV charging (0.2 C, 4.3 V, a termination current of 0.02 C) and the CC discharging (0.2 C, 1 C, 2 C, 5 C, or 10 C, a termination voltage of 2.0 V) were performed.

The CC charge capacity of Sample 17 using RGO as the conductive material was 154.24 mAh/g at 0.2 C, 148.77 mAh/g at 0.5 C, 143.99 mAh/g at 1 C, 138.33 mAh/g at 2 C, and 127.92 mAh/g at 5 C. In contrast, the CC charge capacity of Sample 18 including graphene as the conductive material was 115.4 mAh/g at 0.2 C, 101.0 mAh/g at 0.5 C, 89.35 mAh/g at 1 C, 78.30 mAh/g at 2 C, and 60.88 mAh/g at 5 C. The CC charge capacity of Sample 19 using AB as the conductive material was 120.59 mAh/g at 0.2 C, 107.79 mAh/g at 0.5 C, 99.18 mAh/g at 1 C, 89.76 mAh/g at 2 C, and 76.17 mAh/g at 5 C.

FIG. 37A shows the charge rate characteristics of Samples 17 and 19 at 0° C. FIG. 37B shows the discharge rate characteristics of Samples 17 and 19 at 0° C. The charge and discharge conditions were similar to those in FIGS. 36A and 36B.

As shown in Table 5, FIGS. 36A and 36B, and FIGS. 37A and 37B, Sample 17 using RGO as the conductive material exhibited extremely favorable high rate characteristics, although the weight ratio of the conductive material in Sample 17 was much smaller than those in Sample 18 using graphene and Sample 19 using AB. The charge capacity of Sample 17 was twice or more that of Sample 19 under the conditions of 0.5 C to 5 C and 25° C.

As described above, it was found that when RGO is used as the conductive material in the secondary battery using LFP as the positive electrode active material, the fast charge characteristics and high-output discharge characteristics of the secondary battery were improved. This is probably because the RGO forms a favorable conductive path in the positive electrode active material layer. It was also found that high-output discharge characteristics were improved in the case of using the RGO compared to the case of using graphene. This is probably because the dispersibility of RGO is much higher than that of graphene.

FIG. 38A shows the charge rate characteristics of Samples 20 and 21 at 25° C. FIG. 38B shows the discharge rate characteristics of Samples 20 and 21 at 25° C. The discharging conditions were similar to those in FIGS. 36A and 36B.

As shown in FIG. 38A, even in the case of using NCM523 as the positive electrode active material, Sample 20 using RGO as the conductive material exhibited favorable characteristics particularly in the high-rate charging although the weight ratio of the conductive material was small. This is also probably because the RGO forms a favorable conductive path in the positive electrode active material layer.

FIG. 39A shows the cycle characteristics of Samples 21 and 22 at 25° C. FIG. 39B shows the cycle characteristics of Samples 21 and 22 at 45° C. FIG. 39C shows the cycle characteristics of Samples 21 and 22 at 60° C. The CC charging (0.2 C, a termination voltage of 4.3 V) and the CC discharging (0.2 C, a termination voltage of 2.0 V) were performed.

As shown in FIGS. 39A to 39C, particularly at 60° C., the capacity of Sample 21 using AB as the conductive material significantly decreased with an increase in cycles, and Sample 22 using RGO as the conductive material exhibited extremely excellent cycle characteristics. Also at other temperatures, Sample 22 exhibited better cycle characteristics than Sample 21.

FIG. 40A shows the charge rate characteristics of Samples 21 and 22 at 0° C. The CCCV charging (0.5 C, 1 C, 2 C, 5 C, or 10 C, 4.3 V, a termination current of 0.02 C) and the CC discharging (0.2 C, a termination voltage of 2.0 V) were performed.

FIG. 40B shows the discharge rate characteristics of Samples 21 and 22 at 0° C. The CCCV charging (0.2 C, 4.3 V, a termination current of 0.02 C) and the CC discharging (0.5 C, 1 C, 2 C, 5 C, or 10 C, a termination voltage of 2.0 V) were performed.

FIG. 41A shows the charge curves of Samples 21 and 22 at 1 C at 0° C. FIG. 41B shows the charge curves of Samples 21 and 22 at 0.2 C at 0° C.

As shown in FIG. 40A and FIG. 41A, Sample 21 using AB was rapidly charged by a voltage drop at 0° C. and thus had an extremely low charge capacity. Meanwhile, Sample 22 using RGO had favorable charge capacity also at 2 C.

Moreover, as shown in FIG. 40B and FIG. 41B, Sample 22 had better discharge rate characteristics than Sample 21.

As described above, the secondary battery using RGO was found to have favorable charge and discharge rate characteristics even at a low temperature of 0° C.

### Example 4

In this example, secondary batteries each including a positive electrode including RGO as a conductive material and polysaccharide as a binder were fabricated, and the characteristics thereof were evaluated.

### <Fabrication of Positive Electrode>

As polysaccharide used as the binder, potato starch was used. As in Steps S11 and S12a in FIG. 1, the binder and a solvent were mixed.

In 9 g of water was dispersed 1 g of the starch and mixed in a SUS container while the temperature was raised to 100° C. The mixture was 10 wt % starch paste formed by Method 1. The starch paste was used for Samples 23 and 24.

Moreover, 1 g of starch and 9 g of water were weighed, put into a container for stirring and covered with a lid, and heated in a water bath at 80° C. for 5 minutes. The mixture was 10 wt % starch paste formed by Method 2. The starch paste was used for Samples 25 to 30.

Then, as in Step S12b, the 10 wt % starch paste and the conductive material were mixed. As the conductive material, powdery GO (produced by Graphenea) or amine-modified GO (produced by Graphenea) was used. The GO was used for Samples 23, 24, and 26 to 28. The amine-modified GO was used for Sample 25. Furthermore, Samples 29 and 30, which use AB, were also fabricated as comparative examples. Stirring was performed by a planetary centrifugal mixer (THINKY MIXER produced by THINKY CORPORATION) at 2000 rpm for 3 minutes.

Then, as in Step S12c, a positive electrode active material was mixed into the mixture of the 10 wt % starch paste and the GO. As the positive electrode active material, LFP with no carbon coat was used. Specifically, commercially available LFP (produced by ATR Company) or LFP synthesized by a solid phase method was used. As LFP synthesized by a solid phase method, LFP was synthesized by a solid phase method using lithium carbonate, ammonium dihydrogenphosphate, and iron oxalate dihydrate as raw materials. Stirring by the planetary centrifugal mixer at 2000 rpm for 3 minutes was repeated five times. Water was added as appropriate for viscosity modification. Accordingly, slurry was formed (Step S13).

Next, the slurry was applied on a current collector (Step S14). An aluminum foil with a carbon undercoat was used as the current collector.

After the application, the slurry was dried at 80° C. (Step S15). Then, the current collector and the slurry were stamped out for the CR2032 coin-type secondary battery (with a diameter of 20 mm and a height of 3.2 mm).

Next, reduction treatment was performed (Step S16). As the reduction treatment, only thermal reduction was performed or thermal reduction was performed after chemical reduction. The thermal reduction was performed using a glass tube oven under a reduced pressure (approximately 1 kPa) for 10 hours. The heating time included time for raising the temperature. The temperature rising rate was approximately 11° C./min. The heating temperature was 170° C., 200° C., 250° C., or 300° C.

As a reducing agent for the chemical reduction, ascorbic acid was used. Ethanol was used as a solvent. A 0.078 mol/L L-ascorbic acid ethanol solution was formed and the current collector and the slurry were immersed therein. Then, reaction was caused at 60° C. for one hour.

Sample 27 was subjected to chemical reduction and thermal reduction in this order. The heating time of the thermal reduction was 170° C. Other samples, Samples 23 to 26 and 28 to 30, were subjected to only thermal reduction. The heating temperatures for Samples 23 and 24, Sample 25, Sample 26, Samples 28 and 29, and Sample 30 were 300° C., 250° C., 200° C., 250° C., and 200° C., respectively.

The components undergone the above-described reduction treatment were positive electrodes (Step S18).

Table 6 shows the fabrication conditions of Samples 23 to 30. The mixed amount of the starch as the binder is represented by the weight of the starch contained in the starch paste.

TABLE 6

| | | | | Electrode | | |
|---|---|---|---|---|---|---|
| | Composition proportion | | | Electrode | Carried | |
| | Active | Conductive | | density | amount | Reduction |
| Sample name | material | material | Binder | (g/cc) | (mg/cm²) | method |
| Sample 23 | LFP | GO | Starch | 1.09 | 2.33 | Thermal |
| | (ATR) | 1 wt % | (Method 1) | | | reduction |
| | 94 wt % | | 5 wt % | | | (300° C., |
| | | | | | | 10 h) |
| Sample 24 | LFP | Amine- | Starch | 1.43 | 2.63 | Thermal |
| | (ATR) | modified | (Method 1) | | | reduction |
| | 94 wt % | GO | 5 wt % | | | (300° C., |
| | | 1 wt % | | | | 10 h) |
| Sample 25 | LFP | GO | Starch | 1.31 | 3.92 | Thermal |
| | (ATR) | 1 wt % | (Method 2) | | | reduction |
| | 94 wt % | | 5 wt % | | | (250° C., |
| | | | | | | 10 h) |
| Sample 26 | LFP | GO | Starch | 1.37 | 3.66 | Thermal |
| | (ATR) | 1 wt % | (Method 2) | | | reduction |
| | 94 wt % | | 5 wt % | | | (200° C., |
| | | | | | | 10 h) |
| | | | | | | Chemical |
| | | | | | | reduction |
| Sample 27 | LFP | GO | Starch | 1.31 | 3.87 | ⇒Thermal |
| | (ATR) | 1 wt % | (Method 2) | | | reduction |
| | 94 wt % | | 5 wt % | | | (Ascorbic |
| | | | | | | acid solution |
| | | | | | | 1 h⇒170° C., |
| Sample 28 | LFP | GO | Starch | 1.38 | 4.14 | 10 h) |
| | (Solid phase | 0.8 wt % | (Method 2) | | | Thermal |
| | method) | | 5 wt % | | | reduction |
| | 94.2 wt % | | | | | (250° C., |
| | | | | | | 10 h) |
| Sample 29 | LFP | AB | Starch | 1.26 | 1.64 | Thermal |
| (Comparative | (Solid phase | 10 wt % | (Method 2) | | | reduction |
| example) | method) | | 5 wt % | | | (250° C., |
| | 85 wt % | | | | | 10 h) |
| Sample 30 | LFP | AB | Starch | 1.26 | 1.65 | Thermal |
| (Comparative | (Solid phase | 10 wt % | (Method 2) | | | reduction |
| example) | method) | | 5 wt % | | | (200° C., |
| | 85 wt % | | | | | 10 h) |

### <Fabrication of Secondary Battery>

CR2032 coin-type secondary batteries (20 mm in diameter, 3.2 mm in height) were fabricated using the positive electrodes of Samples 23 to 30 described above.

A lithium metal was used for a counter electrode.

As an electrolyte contained in each electrolytic solution, 1 mol/L lithium hexafluorophosphate (LiPF₆) was used, and as the electrolytic solution, a solution in which ethylene carbonate (EC) and diethyl carbonate (DEC) were mixed at a volume ratio of 3:7 was used.

As a separator, 25-μm-thick polypropylene was used.

A positive electrode can and a negative electrode can that were formed of stainless steel (SUS) were used.

### <SEM>

The positive electrode of Sample 23 fabricated above was observed with an electron microscope. FIGS. 42A and 42B show surface SEM images. FIG. 42A shows a state where RGOs are favorably dispersed in the positive electrode active material layer. FIG. 42B shows a state where the RGO covers a plurality of positive electrode active material particles.

### <Battery Characteristics and Charge Discharge Cycle Characteristics>

Next, Samples 23 to 30 were subjected to a charge and discharge test. As the measurement, the CCCV charging (0.5 C, 4.3 V, a termination current of 0.05 C) and the CC discharging (0.5 C, a termination voltage of 2.5 V) were performed at 25° C. Note that 1 C was set to 170 mA/g in this example and the like.

FIG. 43A shows the charge and discharge curves in first to 50th cycles of Sample 23, and FIG. 43B shows the discharge energy retention rate of Sample 23 as the charge and discharge cycle characteristics. It was found that the positive electrode that uses starch as the binder and GO as the conductive material and was thermally reduced at 300° C. can be sufficiently charged and discharged.

FIG. 44 shows the charge and discharge cycle characteristics of Samples 23 and 24. Sample 23 using GO as the conductive material could be charged and discharged. Meanwhile, Sample 24 using amine-modified GO as the conductive material hardly had discharge capacity. This was probably because the amine-modified GO is less likely to be dispersed in the starch paste than the GO and thus could not form a sufficient conductive path even after reduction.

FIG. 45 shows the charge and discharge characteristics of Samples 25 to 27. Sample 25 thermally reduced at 250° C. exhibited more favorable cycle characteristics than Sample 26 thermally reduced at 200° C. Sample 27 chemically reduced and then thermally reduced at 170° C. could also be sufficiently charged and discharged. Thermal reduction at a high temperature, for example, higher than or equal to 250° C., might decrease the intensity of a positive electrode active material layer depending on the materials of a binder and a positive electrode active material. Therefore, thermal reduction at a relatively low temperature lower than or equal to 200° C. is effective depending on the materials of a binder and a positive electrode active material. In addition, when a non-carbonized part remains in a conductive material, the intensity of a positive electrode active material layer can be increased in some cases.

FIG. 46A shows the charge and discharge curves in first to eighth cycles of Sample 28, and FIG. 46B shows the discharge energy retention rate of Sample 28 as the charge and discharge cycle characteristics. The carried amount of Sample 28 was 4.57 mg/cm². Note that the carried amount refers to the weight of a positive electrode active material per area. In this example and the like, the carried amount was calculated by dividing the weight of the positive electrode active material layer after the reduction by the composition proportion of the positive electrode active material.

FIG. 47A shows the charge and discharge curves in first to 28th cycles of Sample 29, and FIG. 47B shows the discharge energy retention rate of Sample 29 as the charge and discharge cycle characteristics. The carried amount of Sample 29 was 1.64 mg/cm².

FIG. 48A shows the charge and discharge curves in first to 31st cycles of Sample 30, and FIG. 48B shows the discharge energy retention rate of Sample 30 as the charge and discharge cycle characteristics. The carried amount of Sample 30 was 1.65 mg/cm².

Samples 28 to 30 each could be sufficiently charged and discharged. However, in the positive electrode using AB as the conductive material and starch as the binder, the positive electrode active material layer was separated from the current collector very easily after the application of the slurry, and thus it was difficult to fabricate the positive electrode with the carried amount similar to that of Sample 28. Thus, the carried amounts of Samples 29 and 30 needed to be significantly reduced in order to fabricate the positive electrodes and perform charge and discharge.

In contrast, in Sample 28 using GO as the conductive material, a sufficient conductive path was formed even with a small amount of conductive material and the intensity of the positive electrode active material layer was also favorable.

FIG. 49 shows the initial discharge capacities of Samples 28 and 29. The discharge capacity per volume of Sample 28 using GO as the conductive material was 198.0 mAh/cm³, and the discharge capacity per volume of Sample 29 using AB as the conductive material was 158.6 mAh/cm³. As shown in FIG. 49, Sample 28 had a wide plateau and a large discharge capacity, that is, exhibited favorable discharge characteristics.

As described above, the secondary battery using GO as the conductive material and starch as the binder was excellent in terms of the intensity of the positive electrode active material layer, the discharge characteristics, and the like compared to the secondary battery using AB as the conductive material.

This application is based on Japanese Patent Application Serial No. 2019-203821 filed with Japan Patent Office on Nov. 11, 2019 and Japanese Patent Application Serial No. 2020-009100 filed with Japan Patent Office on Jan. 23, 2020, the entire contents of which are hereby incorporated by reference.

What is claimed is:

1. A method for manufacturing a positive electrode for a secondary battery, comprising:
a step of forming slurry by mixing graphene oxide, a binder, and a positive electrode active material in a solvent containing water;
a step of applying the slurry on a positive electrode current collector; and
a step of reducing the graphene oxide,
wherein the step of reducing the graphene oxide comprises at least one of chemical reduction and thermal reduction,
wherein the binder comprises polysaccharide,
wherein the chemical reduction is a step of immersion in a reducing agent solution, and
wherein the thermal reduction is a step of heating at a temperature higher than or equal to 125° C. and lower than or equal to 200° C. for longer than or equal to one hour and shorter than or equal to 20 hours.

2. A method for manufacturing a positive electrode for a secondary battery, comprising:
a step of forming slurry by mixing graphene oxide, a binder, and a positive electrode active material in a solvent containing water;
a step of applying the slurry on a positive electrode current collector; and
a step of reducing the graphene oxide,
wherein the step of reducing the graphene oxide comprises chemical reduction and thermal reduction.

3. The method for manufacturing a positive electrode for a secondary battery, according to claim 2,
wherein the chemical reduction is a step of immersion in a reducing agent solution, and
wherein the thermal reduction is a step of heating at a temperature higher than or equal to 125° C. and lower than or equal to 200° C. for longer than or equal to one hour and shorter than or equal to 20 hours.

4. The method for manufacturing a positive electrode for a secondary battery, according to claim 2,
wherein the binder comprises polysaccharide.

5. The method for manufacturing a positive electrode for a secondary battery, according to claim 4,
wherein the polysaccharide is starch.

6. The method for manufacturing a positive electrode for a secondary battery, according to claim 3,
wherein the reducing agent solution is an ascorbic acid solution.

7. A secondary battery comprising:
a positive electrode;
a negative electrode;
a separator; and
an electrolyte solution,
wherein the positive electrode comprises a positive electrode active material, a conductive material, a binder, and a positive electrode current collector,
wherein the positive electrode active material is lithium iron phosphate, and
wherein the conductive material is reduced graphene oxide.

8. The secondary battery according to claim 7,
wherein the reduced graphene oxide comprises carbon and oxygen,
wherein the reduced graphene oxide comprises a sheet-like shape and a two-dimensional structure formed of a six-membered ring composed of carbon atoms, and
wherein a concentration of carbon is greater than 80 atomic % and a concentration of oxygen is greater than or equal to 2 atomic % and less than or equal to 15 atomic % in part of the reduced graphene oxide.

9. The secondary battery according to claim 7,
wherein G/D which is an intensity ratio of a G band to a D band of a Raman spectrum of the reduced graphene oxide is greater than or equal to 1.

10. The method for manufacturing a positive electrode for a secondary battery, according to claim 1,
wherein the polysaccharide is starch.

11. The method for manufacturing a positive electrode for a secondary battery, according to claim 1,
wherein the reducing agent solution is an ascorbic acid solution.

12. The method for manufacturing a positive electrode for a secondary battery, according to claim 1,
wherein a volume ratio of the water contained in the solution is greater than or equal to 10 volume %, greater than or equal to 50 volume %, or greater than or equal to 90 volume %.

13. The method for manufacturing a positive electrode for a secondary battery, according to claim 2,
wherein a volume ratio of the water contained in the solution is greater than or equal to 10 volume %, greater than or equal to 50 volume %, or greater than or equal to 90 volume %.
